(19) United States
(12) Patent Application Publication
(10) Pub. No.: US 2010/0003652 A1
(43) Pub. Date: Jan. 7, 2010

(54) MISSION TRAINING CENTER INSTRUCTOR OPERATOR STATION APPARATUS AND METHODS USEFUL IN CONJUNCTION THEREWITH

(75) Inventors: Eytan Lavie, Tel Aviv (IL); Eytan Ofry, Holon (IL); Assaf Tamir, Ramat-Gan (IL)

Correspondence Address: OLIFF & BERRIDGE, PLC, P.O. BOX 320850, ALEXANDRIA, VA, 22320-4850, US

(73) Assignee: ISRAEL AEROSPACE INDUSTRIES LTD., Lod (IL)

(21) Appl. No.: 12/514,197

(22) PCT Filed: Nov. 8, 2007
(86) PCT No.: PCT/IL07/01363

§ 371 Date: May 8, 2009

(30) Foreign Application Priority Data
Nov. 9, 2006 (IL) 179142
Nov. 29, 2006 (IL) 179688

(51) Int. Cl. G09B 19/00

(52) U.S. Cl. 434/219

(57) ABSTRACT

Operation manager apparatus for a Mission Training Center system, the apparatus comprising a communication system operative to coordinate two or more participants corresponding to two or more engines; and a real time participant modification functionality operative to carry out at least one modification of at least one characteristic of at least one participant during an exercise, including informing at least one of the two or more participants via the communication system.

### FIELD OF THE INVENTION

The present invention relates generally to distributed tactical flight simulators and Mission Training Centers, also termed “Distributed mission trainer/operation systems” or DMT/DMO.

### BACKGROUND OF THE INVENTION

The following documents are referred to herein:
[1] “High-Level Architecture Rules”, Version 1.3, U.S. Department of Defense, 5 Feb. 1998.
[2] “High Level Architecture Interface Specification”, Version 1.3, U.S. Department of Defense, 2 Apr. 1998.
[3] “High-Level Architecture Object Model Template Specification”, Version 1.3, U.S. Department of Defense, 5 Feb. 1998.

Many different types of combat flight simulators are known. The disclosures of all publications and patent documents describing these, and of the publications and patent documents cited therein or herein directly or indirectly, are hereby incorporated by reference.

### SUMMARY OF THE INVENTION

The present invention seeks to provide an improved system for management and control of mission training centers. A mission training center includes any facility devoted to training based on simulators.

The following terms may encompass the following definitions or may alternatively be construed as used in the art:

Constructive Simulation: Models and simulations that involve simulated people (Artificial Intelligence) operating simulated systems.

Live Simulation: A simulation involving real people operating real systems.

Virtual Simulation: A simulation involving real people operating simulated systems.

Scenario: The envelope of definitions and properties defining the exercise Computer Generated Forces and peripheral aspects. The definitions may include entity type, entity properties, entity locations, environment properties, weather properties and any other property needed by the exercise.

Exercise: The complete real-time training situation. The exercise holds the scenario and may add to it the Live and Virtual Simulations. The exercise also includes additional parameters and rules typically used by all participants. Typically, an exercise includes a preparation or set-up stage in which only the instructor may take part, or, alternatively or in addition, participants may take part, and a participation or operation stage in which rehearsal of the mission actually occurs.

Examples of participant, shell, or engine characteristics which may be modified during exercise set-up and/or operation, include modification of fuelling properties, modifications of the flight route, modification of communication channels, modifying the amount of type of armaments, and modification of the cockpit configuration (e.g. class B, class D).

The terms “shell” is used herein to indicate a pre-defined role in an exercise. The term “cast” may be used to indicate a set of shells defined for an exercise which is eventually populated by a corresponding set of engines. Shell characteristics are typically defined; typically, where an engine populating a shell, also termed herein a “participant”, has a characteristic which contradicts the corresponding shell characteristic, the engine's characteristic overrides or prevails. For example, if the exercise was defined to include a shell, Blue3, having a class B cockpit, and the engine found to populate Blue3 has a class D cockpit, the exercise proceeds on the assumption that Blue3 has a class D cockpit.

The following acronyms are used:

API Application Programmer Interface

BIT Built-In-Test

COTS Commercial off the shelf

CGF Computer Generated Forces

CSCI Computer Software Configuration Item

DIS Distributed Interactive Simulation

DMO Distributed Mission Operation

DMT Distributed Mission Training

FOM Federation Object Model

HLA High Level Architecture

HUD

HW Hardware

IG Image Generator

IOS

OTW

PC Personal Computer

SOM Simulation Object Model

SSDD System/Subsystem Design Description

SW Software

RPR FOM Real-time Platform Reference Federation Object Model

RTI Runtime Infrastructure

### BRIEF DESCRIPTION OF THE DRAWINGS

Certain embodiments of the present invention are illustrated in the following drawings:

FIGS. 1-3, 4A-4B, 5-10, 11A-11B, 12A-12D, 13-17, 18A-18B, 19-28, 29A-29C, 30-34 are simplified screenshots representing screen displays and portions thereof, block diagrams, tables and other illustrations together representing certain embodiments of a Mission Training Center instructor operator station apparatus and methods useful in conjunction therewith.

FIGS. 35-43, 44A-44B, 45-55 illustrate elements of a Distributed Mission Operation (Mission Training Center) Instructor Operator Station (IOS) constructed and operative in accordance with another embodiment of the present invention, some or all features of which may, if desired, be combined with some or all features of the system shown and described herein with reference to FIGS. 1-34. In particular:

FIG. 35 illustrates a General configuration of the DMT Mission Training Center according to certain embodiments of the invention.

FIG. 36 illustrates a DMT Mission Training Center development process according to certain embodiments of the invention.

FIG. 37 illustrates a F-16 Single Seat Desktop Simulator Block Diagram according to certain embodiments of the invention.

FIG. 38 illustrates a F-16 Single Seat Desktop Simulator Block Diagram according to certain embodiments of the invention.

FIG. 39 illustrates a F-16 Cockpit Simulator Block Diagram according to certain embodiments of the invention.

FIG. 40 illustrates a IOS Block Diagram according to certain embodiments of the invention.

FIG. 41 illustrates a Image Generator and OTW Displays\Domes Block Diagram according to certain embodiments of the invention.

FIG. 42 illustrates a Ground Control Station Block Diagram according to certain embodiments of the invention.

FIG. 43 illustrates a DMT Mission Training Center Voice & Video Communication Block Diagram according to certain embodiments of the invention.

FIG. 44A illustrates a Mission Training Center State Transition Diagram according to certain embodiments of the invention.

FIG. 44B illustrates a Exercise State Transition Diagram according to certain embodiments of the invention.

FIG. 45 illustrates a Control Facility State Transition Diagram according to certain embodiments of the invention.

FIG. 46 illustrates a IOS State Transition Diagram according to certain embodiments of the invention.

FIG. 47 illustrates a IOS Startup State Diagram according to certain embodiments of the invention.

FIG. 48 illustrates a IOS Preparation state diagram according to certain embodiments of the invention.

FIG. 49 illustrates a Preparation state diagram according to certain embodiments of the invention.

FIG. 50 illustrates a Post Exercise state diagram according to certain embodiments of the invention.

FIG. 51 illustrates a Simulator/CGF Computer Generated Forces State Transition Diagram according to certain embodiments of the invention.

FIG. 52 illustrates a Simulator/CGF Computer Generated Forces Startup State Diagram according to certain embodiments of the invention.

FIG. 53 illustrates a Simulator/CGF Computer Generated Forces Startup State Diagram according to certain embodiments of the invention.

FIG. 54 illustrates a Simulator/CGF Computer Generated Forces preparation state diagram according to certain embodiments of the invention.

FIG. 55 illustrates a Post Exercise state diagram according to certain embodiments of the invention.

FIG. 56 is useful in understanding suitable data structures useful in accordance with certain embodiments of the present invention, including an exercise database, scenario database, area database, environment database, shell database and engine database, which data structures may, for example, reside in the exercise control and database 170 of FIG. 1.

FIG. 57 is useful in understanding a suitable architecture for a Mission Training Center manager constructed and operative in accordance with certain embodiments of the present invention.

FIGS. 58-59 are useful in understanding an example of an operation management session operative in accordance with certain embodiments of the present invention.

FIG. 60 is a table presenting display information generated by various of the modules of FIG. 1.

### DETAILED DESCRIPTION OF CERTAIN EMBODIMENTS

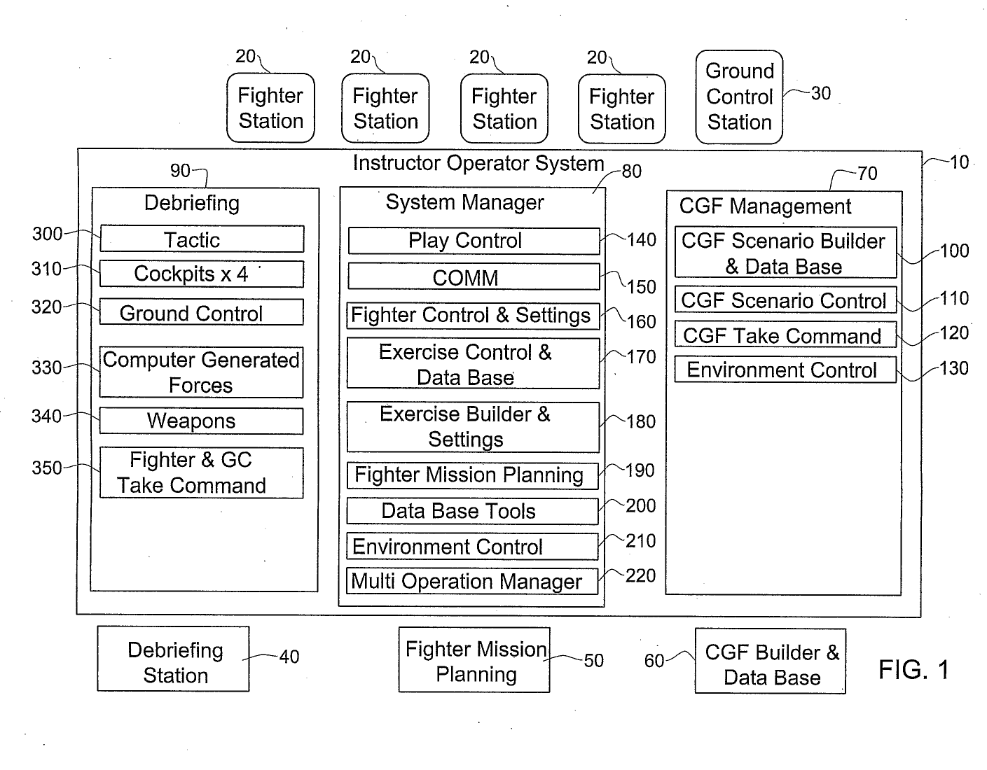

A Distributed Mission Operation (Mission Training Center) Instructor Operator Station (IOS) constructed and operative in accordance with certain embodiments of the present invention is now described with reference to FIG. 1. The IOS may support different Aircraft types and support connecting a local Mission Training Center to a full LVC operation. The local mission training center may communicate with remote counterparts using a suitable protocol such as HLA (high level architecture).

The Mission Training Center may comprise a complex supporting a number of typically simulated Fighter stations 20 (e.g. single or two seaters), a Ground Control station 30, an Instructor operator station 10, a Debriefing station 40, a Mission Planning station 50 and a Computer Generated Forces Builder and database Station 60.

The Fighter Station 20 may comprise the station where the Pilot/Aircrew train. The station type may range from a full simulator to a limited cockpit or a desktop PC. Every station typically supports the Aircraft's operational avionics and full communication capabilities e.g. COMM & DATA LINK.

The Ground Control Station 30 may comprise the station where the GCI and C4I train. The station type may range from a full GCI simulation to a limited tactical display. Every station typically supports full communication capabilities.

The Instructor operator station 10 is typically the Station controlling and managing the entire Mission Training Center System and fully linking it to other mission training centers and live entities. The Stations typically comprise Debriefing module 90, System Manager module 80 and Computer Generated Forces Manager module 70. It is appreciated that the blocks shown in FIG. 1 represent functional units rather than, necessarily, architectural modules. The system manager module 80 may comprise the “play” control for the trainees, COMM control 150 (both radio and intercom), Fighter control and settings 160, Mission control and settings 180, Deductive Tools 200 and the Multi-Operation Manager 202. The Station 10 is typically linked to additional Debriefing, Mission Planning, and Computer Generated Forces control stations 40, 50 and 60 respectively. These additional systems may be separate and parallel to the main Station 10.

The Debriefing Station 40 supports a spectrum of different levels, typically comprising some or all of: tactical replays 300 of all that occurred in the theater, cockpit level debriefing 310 which includes all the operations performed by the crew, Computer Generated Forces debriefing 330 allowing to replay Computer Generated Forces behavior and to better assess the inter-action with the Computer Generated Forces, and weapons debriefing 340 allowing full assessment of the weapon behavior and success/failure reasons.

The Fighter Mission Planning Station 50 is typically used to upload all mission data the Aircraft uses.

The Computer Generated Forces Builder & Data Base Station 60 supports the creation and editing of all Computer Generated Forces generated within the Mission Training Center system. The Builder may support Data Base creation and management. Both offline and real-time editing are typically supported.

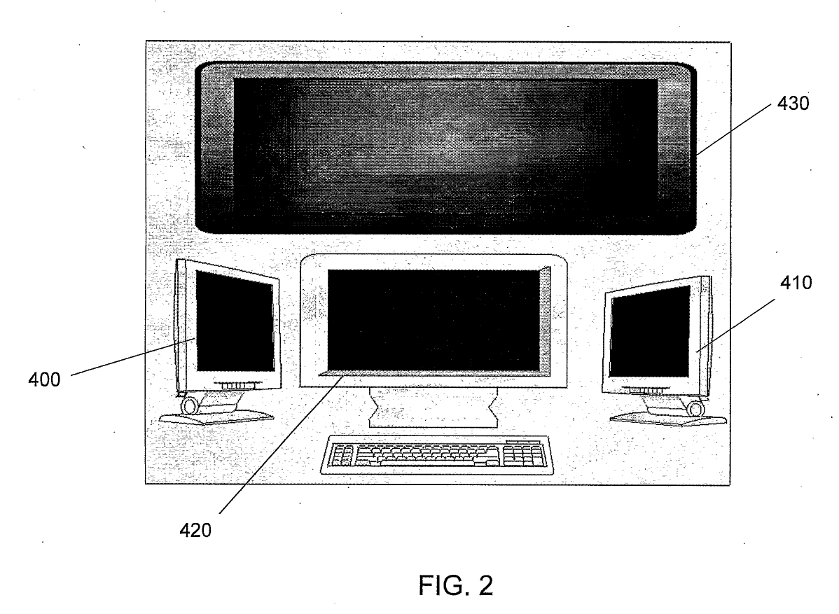

The Instructor operator station 10 may comprise four displays e.g. as shown in FIG. 2: Two tabletop displays 400 and 410, one central tabletop display 420 and one wall display 430. The tabletop displays may be divided according to the main three system categories: Debriefing, System manager and Computer Generated Forces manager. The wall display 430 may support a number of different displays selected by the user via software. Among the displays: 3D tactical, 2D God view and re-display of some windows used in the Instructor operator station. Combining the three tabletop screens 400, 410 and 420 into one large screen is one possible embodiment, creating a final display of two large screens one above the other.

The station may support two users, managers, at the same time. Therefore, suitable physical controllers e.g. two sets of keyboards and two sets of mouse controllers may be available. The main set may have a controller allowing the user to switch the keyboard and mouse control between the different screens. The second set may only support the Computer Generated Forces station 70.

The Communication Physical Layout may comprise headsets with earphones and microphones for users. Each user also typically has a leg pedal type transmit switch. The headsets may be wireless. In addition, a speaker and a microphone may be available for other users. The leg action may transmit as “Radio” Communication. The intercoms transmit and selection may be available through an additional intercom box. For each endpoint, the following manual switches may be available: On/Off, volume control and optionally VOX control, where transmission may occur when above threshold. Selection of transmit and listening channels typically occurs through software.

The Wall Display 430 may display various windows from the Instructor operator station 10. The display logic may be automatic or manual. The automatic mode may dynamically change according to user screen selection. Adding a second window may cause the display to split in half and display both windows. The manual mode may allow the user to select how and where each window may be located on the display. Selection of which windows to display on the wall display 430 is typically effected using software. Any window from all three tabletop displays 400, 410 and 420 may be displayed on the wall. A window, displayed on the top screen 430, may also be open on one of the tabletop computers. The window may be minimized. There is typically no separation between off-line and real-time operations. All functions may be supported in both modes.

All of the System manager components may be controlled through one main screen. The system manager 80 also has a number of controls that interact with the Computer Generated Forces management system 70 and the Debriefing system 90 e.g. as described hereinbelow.

The System Manager 80 may include a number of main sections, some overlapping with each other. The sections may be: Play Control 140, COMM 150, Fighter Control 160, Mission Control, Instruction Data Base Tools 200, Mission Planning 190 and the Operation Control 220.

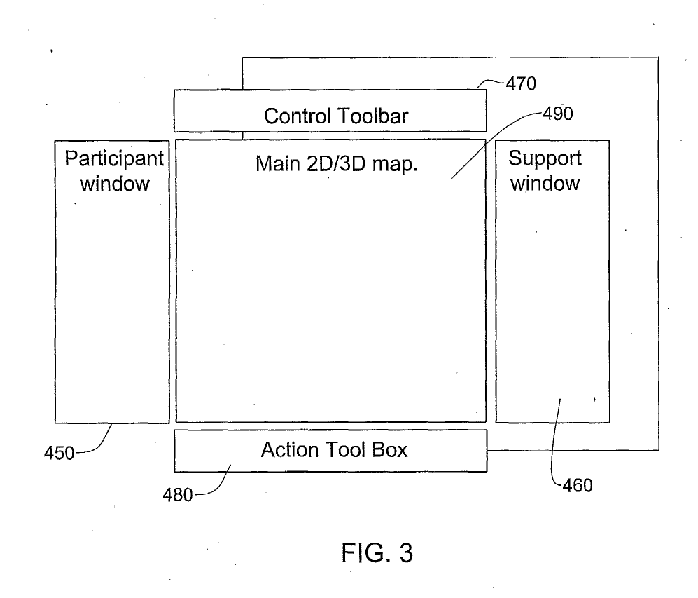

FIG. 3 is a simplified pictorial illustration of a main screen, typically including some or all of a participant window 450, a support window 460, a control toolbar 470 and an action toolbox 480.

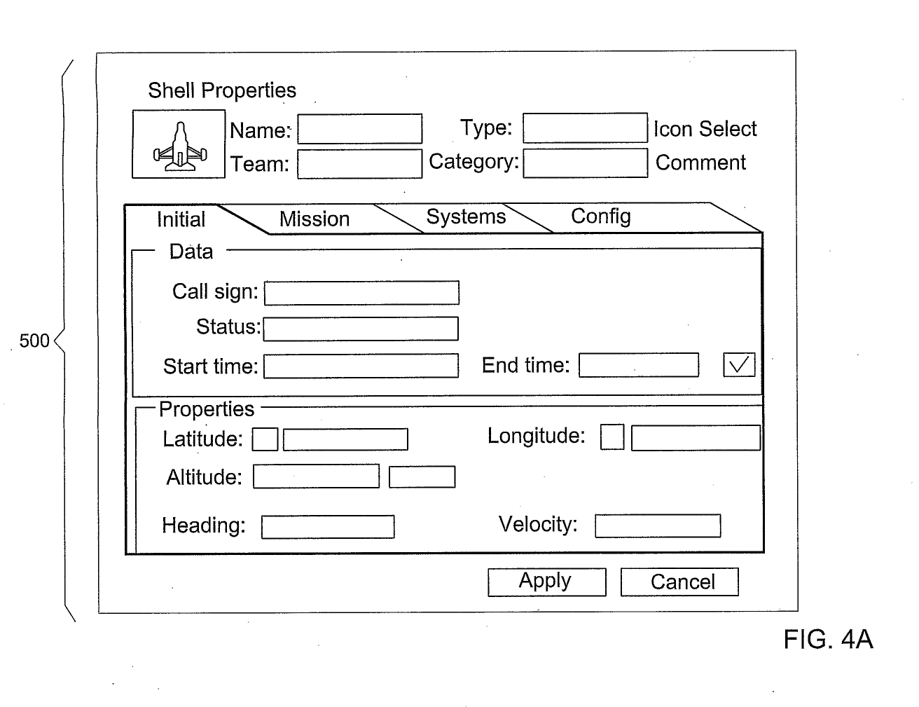

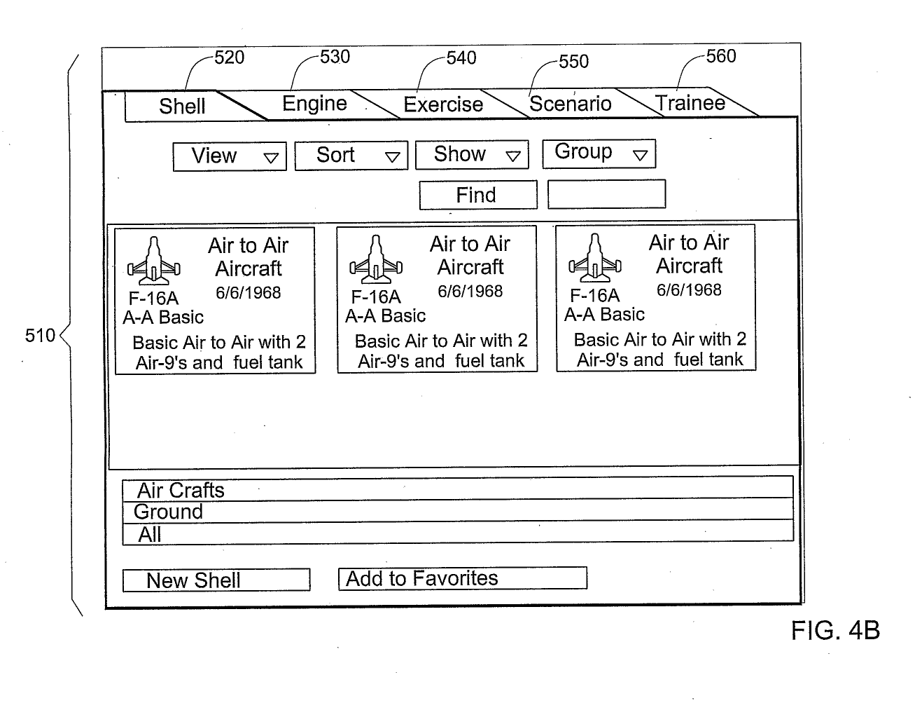

FIGS. 4A and 4B taken together, comprise a simplified pictorial illustration of a Participant window constructed and operative in accordance with an embodiment of the invention. The window holds all the participants set in the scenario. Each participant is typically displayed through an icon on the map and through a data/command box in the participant window. Selecting participants is typically effected either by icon selection or by data box selection.

The support window 460 holds the entire database supporting the system. The window typically is tab controlled and switches between a number of different main database subjects. A selection may be added to an exercise by simply dragging it to the map. Double clicking a selection typically enables property editing and more (entity type dependent).

The control toolbar 470 holds a number of different toolbars. The main toolbar holds all the basic control buttons of a system such as save and copy. An additional toolbar is typically dynamic and changes according to the selected actions. The exercise control toolbar typically allows full exercise play, pause, time mark and return options.

The action Toolbox 480 holds a number of different boxes. Dragging a subject to a box typically executes the action held by that box, a Windows recycle bin typically being a type of an action box. The action toolboxes may include COMM control, CHAT & VOIP control, and specific delete and pause function.

An “engine” typically comprises the system driving the entity in the exercise. A set of engines may include some or all of Computer Generated Forces, real aircrafts, local fighter stations, other Mission Training Center Stations etc. The online and offline engine list is typically located on the engine tab in the Support window. There may be two main groups of engines, local and external. The local engine is located in this specific Mission Training Center and controlled by, for example, the local Fighter Stations and Local Computer Generated Forces server. The external engines include any engine, from any source, outside of the local Mission Training Center.

A “shell” typically comprises a set of parameters which may be passed to the engine when the engine is linked to the shell. The parameters may be entity dependent. There may be a number of different shells held in the database. The shell types include but are typically not limited to Fighter Aircrafts, Helicopters, and SAMs. The shells are typically also editable and new options may be added to the database. The basic parameters may include initial location, altitude, direction, speed, start and end time etc. For a local fighter, the shell may also define the fighter configuration and for a generic fighter the shell may define the fighter type. The Shell icons may be located on the Shell tab in the Support window.

In order to control and coordinate all the different entity types through one interface, the manager is typically enabled to create exercises when some of the participating engines are not online yet. The solution is typically to use a two-step planning system. The first step is typically to plan the entire exercise using only shells (ghosts) representing the future participants. The second step is typically to link the incoming engines (online servers, simulators, aircrafts . . . ) to their shells. The two-step method may be overridden by adding an engine directly to the exercise.

Participant definition: The Participant is typically an entity that is completely defined and logged on to the exercise. Linking an engine to a Shell is that action which defines the participant.

According to certain embodiments of the present invention, at least one characteristic of at least one participant can be modified even during exercise operation e.g. upon request from the engine. The engine's characteristics typically do not change.

Linking an Engine to a Shell: The linking action is typically effected by dragging an engine icon onto a shell icon which has already been placed on the map. A shortcut is placement of an engine directly onto the map. In the shortcut method an automatic shell may be created and the engine's default parameters may define the shell parameters. During a regular link, for external engines, the link action may try to pass the parameters to the external engine's source. The data may be sent at a number of different levels, from complete automation to a simple text message requesting the engine controller to update his system. For real aircraft the parameters may be disregarded by the aircraft, however the participating entities may not see the aircraft until their start time has begun. The start time is typically set in the Shell parameters.

The Multi-Operation Manager 220 is typically the component in the IOS which supports linking this specific Mission Training Center to other participants in a complete LVC operation. Some end-points in the LVC Operation have a type of a manager, which allows participation, creation and viewing of LVC Operations. Other end-points may not have such a manager. The manager may be able to coordinate with all types of end-users, typically assuming that they use a suitable protocol such as HLA protocol to exchange data. The logic behind each operation is typically based on a host, which creates and controls the exercise and a number of clients who join the exercise.

Operation Setup: The creation of a complete operation may comprise some or all of the following components: (a) Setting the training area, (b) setting the participants, (c) setting the rules, (d) real-time control of the Operation including real-time control of certain participants, (e) allocating control of different parameters and participants, and (f) exercise coordination. Each of these is now described in detail:

(a) Setting the area of training. A number of parameters define the training area: area borders, area minimum and maximum altitude and operation start/end time. The area may define where all participants exist and interact. A certain participant may receive his own start/end times and until those times, that participant may not exist for the other participants.

(b) Setting the Participants: Setting participants typically comprise two steps. The first step is typically constructing the scenario by placing the entities at their initial location and setting their parameters. The second step is typically linking each engine with its entity e.g. shell. An additional option for the host is to create an exercise where the host only accepts the clients and each client enters the exercise with its own complete definitions. In the second option, one client may import a number of participants into the host.

Setting the entity's parameters is typically dependent on the entity type. The parameters may include some or all of: entity type, name, location, altitude, speed, direction, configuration, and doctrines. Upon adopting an entity, the client may view the parameters as a list and accept automatically the parameters or manually enter them into his system. Once the host has selected the exercise to be run, he waits for the clients to join the exercise. The clients have a list of all running exercises and may request to join any of them. The exercises may be password protected. When a client selects to join, he may select which of its engines may participate in this exercise. For example: A Mission Training Center instructor may select the cockpit fighter he wants in the game while a Computer Generated Forces manager may select which Computer Generated Forces should participate. The client may preview the scenario before joining.

(c) Setting the Rules: Every Operation is typically accompanied by a set of rules independent of the participating entities. Examples of rules are: Neutral Areas, and crash enable/disable.

(d) Real-time Control: The Operation Real-Time control supports full play control, event control and some entity control. The amount of entity control is typically entity dependent. Control of a System Fighter is typically greater than the control of Computer Generated Forces. Through the Manager System, full control of Computer Generated Forces is typically still available via the real time system. Entities that cannot be controlled may be displayed in the manager stations.

(e) Allocating Control: Typically, when a Computer Generated Forces Server is dragged and dropped onto the map without a specific Shell, the Computer Generated Forces Server is given free access to the exercise and can insert and edit its own objects without IOS supervision.

(f) Exercise Coordination. Each mission training center manager may enable Chat, Voice and Video over IP with mission training center managers.

Referring again to FIG. 1, the Exercise Builder & Database 170 typically holds all Exercises created, saved and available on the network.

The saved Exercises may hold within them all sub-definitions specified herein. Editing a sub-definition may update all Exercise types holding those sub-definitions. A suitable warning may be displayed to accompany this update.

The local exercise database is typically fully updateable by the system manager. A non-local exercise opened for editing by the system manager is typically updateable, however, saving the changes in a non-local manner may require authorization of the source maintaining the exercise. Some Data Base objects may be locked and editing them may only be possible for the user who locked the object.

Suitable exercise builder & Settings 180 may be provided.

Fighter Control & Settings 160: The Fighter Control Section handles all functions related to the Fighter Stations within the Mission Training Center, e.g. functions (a) to (j) now described:

(a) Fighter Selection. The Instructor may select from the database a Fighter type and link it to a Station number. The Station numbers may, for example, be one through four. The Fighter type is typically a combination of settings saved under a unique name in the Fighter database. The different Fighter settings may be specified in the Fighter Database Section. For aircraft-specific Fighter Stations, the Fighter types deal with configurations and settings. For generic Fighter Stations Fighter types include the selection of actual Aircraft type and then configurations and settings. Examples of Fighter options include: F-16C, F-16C Air-to-Air 1, F-16C Air-to-Ground 12, F-5B, F-5B Air-to-Air 1.

(b) Fighter Configuration setup: Different Configurations may be created, edited and deleted. These Configurations may be saved to the Fighter Database and then may be linked to a Fighter. Updating a Configuration may update the Fighter settings when the Fighter is typically offline and online.

(c) Fighter Weapons Loads e.g. Requested Air-to-Air Weapons such as Aim-9L, Aim-120 (A, B, C), Aim-7M and Guns; and/or requested Air-to-Ground Weapons such as MK-84, MK-83, MK-82 and Guns.

(d) Fighter Fuel Amounts & Loads: Setting the amount may be limited to the Aircraft's capabilities and configuration. External Fuel tanks may be loaded according to Aircraft type.

(e) Fighter Chaff & Flare Loads. Setting the amount may be limited to correspond to the capabilities and configuration of the particular aircraft e.g. the Aircraft may, if appropriate to its capabilities and configuration, be loaded with, say, up to 30 Flares and 30 Chaff.

(f) Fighter Data Base: The Fighter Database typically holds all Fighter Types, Configurations and Mission plans. Fighter types typically hold with them Configurations and/or Mission plans. Editing a Configuration may update all Fighter types holding that configuration. A suitable accompanying warning may be displayed. Some Data Base objects may be locked and editing them may only be possible for Administrator type users.

(g) Fighter Real-Time Control: All Options in the entire system may be edited in real-time as well as offline. This section typically deals with specific Fighter real-time Control.

(h) Fighter Action Control. Multiple categories of fighter action may be provided e.g.

(I) Active: Full participation in the Operation;

(II) Fighter Frozen: Fighter is typically frozen in its current parameters and location. The Fighter's view of the Operation is typically also frozen. The actual Operation continues and other entities do not see the frozen Fighter. Release of the frozen mode may return the Fighter to the Operation, which has continued. The return location may remain at its frozen location.

(III) Off-line: The Fighter Station is typically disconnected from the Operation. The Fighter visual may blacken. The Fighter may not be displayed in the Operation. Returning the Fighter to the Operation may require setting an initial location.

(IV) Viewing mode: The Fighter may operate all functions in the Operation such as but not limited to flying, target locking, and firing. The Operation may disregard the Fighter, its actions and radio communication. The Fighter may be either frozen or Active.

(V) Take Control: The Instructor may take control of a specific system in the Fighter or of the entire Fighter. The control may be through Stick, Throttle and mouse command connected to the IOS.

(i) Fighter Location may comprise:

(I) In the air or on the ground. The possible ground locations for the Fighter may be according to the database. At least two different locations may be employed.

(II) Latitude Longitude or Relative to other aircraft. Setting the Fighter is possible e.g. by manually entering coordinates, by dragging the Fighter icon and dropping it on the map, by selecting a preset location, and/or by selecting a preset relative location. The location may be relative to other Fighters (formation settings), and/or relative to objects such as waypoints, threats, and other objects.

(j) Fighter Flight Data may include one or more of: Speed (Ground, TAS, CAS); Direction. (True, Magnetic); Altitude. (Barometric or Above Ground Level); Fighter Mission Planning 190: Different Fighter Missions may be loaded to the Fighter. The missions may include one or more of: Flight routes, Threat estimated positions, Weapon release programs, Communication programming, and Fighter defaults.

Data Base Tools 200: The tools typically comprise maps. Map selection may be achieved by a number of different methods. Selecting an exercise may automatically select the corresponding map. A specific map may be selected from the map list. The map list is typically reached through the support window.

Suitable Control of environment e.g. weather conditions may be provided in module 210.

Play Control 140: The Operation may work in a continuous mode where different entities may join the exercise without stopping the exercise.

COMM 150: The Comm support may enable any fighter, in the Mission Training Center, to fully communicate with another real fighter in the air, another fighter in the same Mission Training Center and/or another fighter in a different Mission Training Center.

A Computer Generated Forces Manager 70 may be provided to manage the Computer Generated Forces; the Computer Generated Forces may be built by a Computer Generated Forces Builder 100.

The Scenario selected is typically created, edited and controlled by the System Manager. Full Database support is typically required. The Computer Generated Forces objects provided may for example include: Aircrafts such as Mig-21, Mig-23, Mig-25, Mig-29, Su-24, F-16, F-18, Su-27, F-15, F-14; SAMs such as SA-2, SA-3, SA-6, SA-8, HAWK, Patriot, SA-10; AAA such as TSU-23; and Ground Targets such as Tanks, Trucks, Bunkers, Airfields, Radars, Buildings, Roads, Bridges, flora, antennas, wires, power plants.

Suitable Computer Generated Forces Control and Computer Generated Forces Take Command modules 110 and 120 may be provided.

Environment Control 130: The Environment Settings include one or more of: Weather; Day/Night; Sun/Moon location; Temperature; Wind; and Rain/Fog/Humidity.

The Lighting setting may be selected in two ways. Automatic lighting—lighting is typically set according to date and time; and Manual lighting—each parameter may be set independently.

Computer Generated Forces controlled through the System Manager. Control of some properties and definitions of Computer Generated Forces through the system manager is typically required. The user may be able to change these parameters through the system manager interface although the Computer Generated Forces is typically driven by a different system. The parameters provided may be one or more of: Location. (Geo, Alt); Flight Parameters (Direction, Velocity); Doctrine (Selected from a doctrine list, created in the original Computer Generated Forces system); Attack Orientation (Telling the entity which other entity it may attempt to attack).

Debriefing module 90. Some or all of the following functional units may for example be provided: Debriefing Tactical unit 300, Debriefing Cockpit 310, Debriefing Ground Control unit 320, Debriefing Computer Generated Forces unit 330, Debriefing Weapons unit 340, and Fighter and GC Take Command unit 350.

Ground Control Station 30 typically replicates a real ground control station.

A ground control station may include a 2D display and full simulated radio operation. The station may be based on a table top PC.

Debriefing Station 40: In addition to the debriefing system that is typically a part of the IOS an additional station, located in a debriefing room is optionally provided. The complete debriefing system is typically based on the MLM debriefing system commercially available from the MLM division of Israel Aircraft Industries.

Fighter Mission Planning Station 50: In addition to the mission planning system, which is typically a part of the IOS, an additional station, located in a different location, may be provided. The database between the two stations may support import and export of data. The specific mission planning definitions may be Fighter type dependent.

Computer Generated Forces Builder & Database Station 60: In addition to the Computer Generated Forces builder & Database system, that is typically a part of the IOS, an additional station, located in a different location, may be provided. The database between the two stations may support import and export of data. The IOS may, also, be able to receive Computer Generated Forces directly from the second station.

Creating an Exercise: The Mission Training Center IOS 10 of FIG. 1 creates or joins exercises that may be run both locally and globally. The initial creation may be done without having the actual participating servers online. The solution typically involves using a two-step method. The first step is only to create the initial exercise parameters. These parameters include the initial location of all future participants, their entity types, their configurations, their doctrines and more entity type dependent parameters. The second step is to link each entity's initial parameters (The Shell) with its driver (The Engine). The link may be done graphically by dragging the engine icon onto a Shell or through tables, specified later on. The link phase requires the engine to be online. The graphical link actually causes a request from the IOS to the engine. The request carries all the parameters set in the Shell. The engine may override the request, in which case, typically, at least one overridden characteristic of the relevant participant will be the characteristic of the engine rather than the requested characteristic namely the corresponding characteristic of the shell populated by the engine. For example, if an entity type is requested from a Computer Generated Forces server that does not know how to support some of the parameters, it may ignore them.

Exercise Building Blocks: Different Shells may be created and saved in the Shell database. Different Engines, that have logged on in the past, may be saved in the Engine database. A collection of Shells, with or without their defined Engines, may be saved under the Scenarios database. Different Scenarios may be saved into Exercises in the Exercise database. Each and every building block may be edited, saved and loaded at any time except for the Exercise. This means while running an exercise, an additional scenario may be added. Shells may be added or removed, their parameters edited and saved. To manipulate a different Exercise the user is typically required to exit the existing Exercise.

FIGS. 4A and 4B, taken together, illustrate a Support Section also termed herein “support window 460”. The support section holds all the data employed for construction and manipulation of exercises and all of its components. The support window is typically separated into two main windows, the properties window 500 and the database window 510.

The Database Window 510: The Database window includes a large number of tabs through which different subject may be accessed. Each subject has its own different display and functions. Object selection is typically effected through the database, however, object manipulation is typically done through the properties window. The Database tabs may include: Shell tab 520, Engine tab 530, Exercise tab 540, Scenario tab 550, Trainee tab 560, Events and Area tabs (not shown).

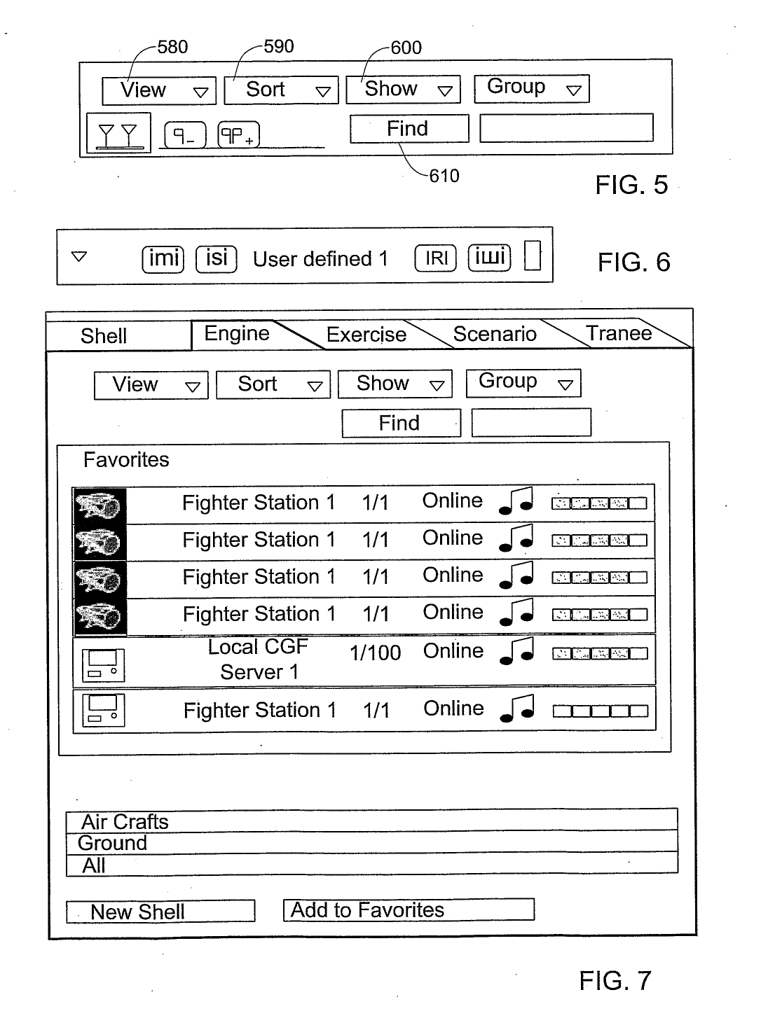

The Shell Database typically comprises a Data Control Menu e.g. as shown in FIG. 5. The control holds the same functions in the database section as in the participants section. Specific functions which are disabled may be shown as grayed out. Views controlled by control field 580 may include some of all of these options:

a. Expand all—expand all the participants to maximized view. Expand is typically disabled in the Shell database.

b. Collapse all—collapse all participants to minimized view. Collapse is typically disabled in the Shell database.

c. Sorting, controlled by control field 590, may include these Options:

(a) By name—the group headers may remain. The objects inside each group may be sorted according to their name.

(b) By Energy—the group headers may remain. The objects inside each group may be sorted according to their energy.

The By Energy function is typically disabled in the Shell database.

(c) By groups—(default)

(d) By colors—the group headers may remain. The objects inside each group may be sorted according to their teams, green\red\blue.

Showing, controlled by control field 600, may include these options:

(a) All: The group headers are removed. All the objects may be displayed in one header. Sort is typically also available on the All display.

(b) Group. As shown in FIG. 6, the objects may be displayed in the groups type display. The Group bar has two display options: The Participant display option as shown and the Database display which is typically similar but doesn't have the command buttons.

New group: After focusing on some objects and selecting the group>new, a new group may be created at the bottom with the objects. The group may be in a different color. The name for the group may be defined after the creation by typing the text into the group heading. This may be changed also later by double click on the name. The default name may for example be “user defined 1” as shown.

Remove group: Only user defined groups may be removed by focus on the group heading and choose the remove. This feature is typically enabled only if the Show>by groups is typically chosen.

Find button 610: After typing the name/call sign and clicking the find, the objects found (all names/call signs that start with the typed text) may be expanded and focused. All other pre focus objects may be unfocused. When changing between the all the view\sort\show options while objects are in focus it may remain in focus unless it is not included in the new view\sort\show option.

Selecting a Shell: Single left clicking a shell highlights the selected shell window. Double clicking a shell highlights the selected shell window and opens the shells properties in the properties window.

Referring to FIG. 4B, the Shell data window 510 displays information about the Shell. The information is typically set through the Shell properties windows of FIG. 4A. The data in window 510 includes the shell icon, name, comment, type, category, date last edited and four status icons. The Shell name is typically colored according to the team selected. The status icons may be either filled or hollow displaying different system statuses. The Shell icon also displays the selected team e.g. by coloring a part of the icon. For an aircraft, the coloring is typically of the nose and tails in the icon. Editing shell parameters is typically effected through the properties window. Some of the parameters may also be edited graphically through the 3D map. One embodiment of the Properties window of FIG. 4A is described in more detail below.

The Engine Database of FIG. 7 typically stores a list of all potential engines in the system. The potential engines include internal and external systems. Examples of the internal engine systems are the fighter stations and the local Computer Generated Forces. Examples of external engine systems are external Computer Generated Forces and additional fighter stations from an additional simulator.

In the Data manipulation section, the manipulation buttons and “find” function may be the same as in the Participants window.

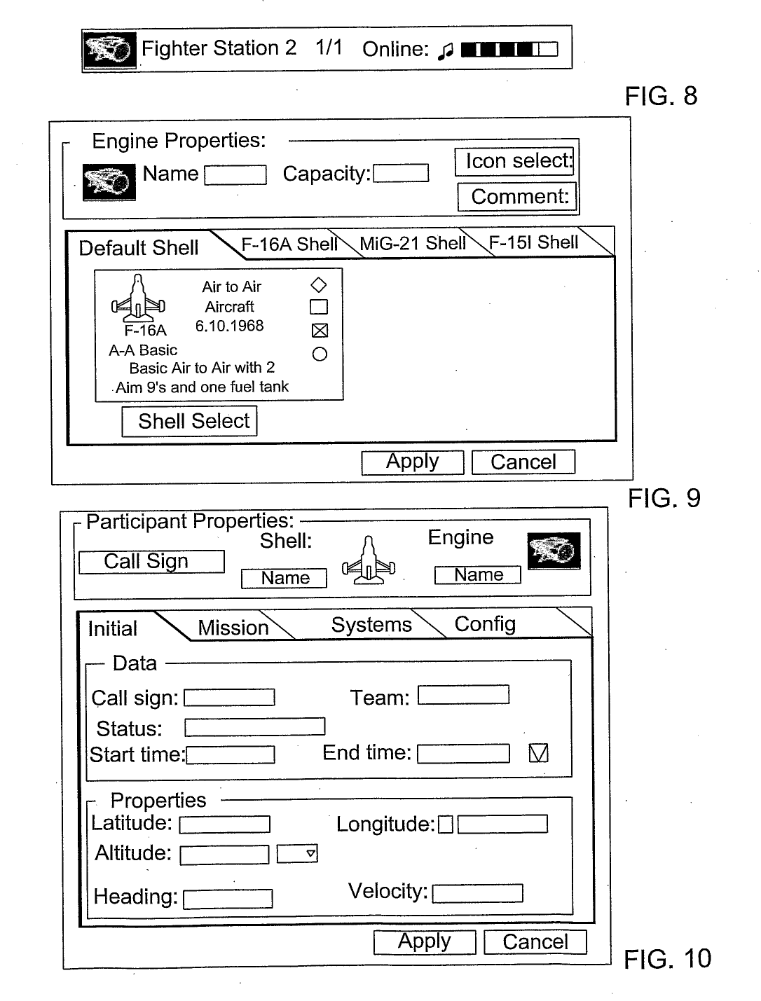

The Engine Data Window of FIG. 8 is now described. The Engine Icon and Engine Name is typically selected through the engine properties window. The Engine usage capacity describes how many entities the engine can support and how many entities have been linked to the engine. For example, if a Computer Generated Forces can support up to 100 entities and 4 have been linked to the exercise, the display may show 4/100. When the capacity is full, the engine may not be available for additional linking.

The Engine Status may for example be one of the following: (a) Online—The engine is available for linking and for participant running. (Green colored); (b) Offline—The engine is offline. (Gray colored); and (c) STBY—The engine is online, available for linking but not for running a participant (Yellow colored).

In the illustrated embodiment, the Engine Running Icon is green and full when the engine is linked and running at least one participant. When offline—the icon has one appearance, e.g. is typically empty and gray colored. When STBY—the icon may have a different appearance e.g. be empty and yellow.

The Engine Communication Health shows the communication health of the engine.

If a default shell has not been selected for an engine, the shell display in the engine properties window may remain empty. Dragging and dropping an engine onto the map, if no default shell has been defined, may not be possible. Instead, a suitable message may prompt: “A default Shell has not been defined for the engine”, and the Engine properties window may be displayed with the default Shell tab.

Creating an Exercise: The Mission Training Center IOS creates or joins exercises that may be run both locally and globally. The initial creation may be done without having the actual participating servers online. The solution for this case is by using a two step method. The first step is only to create the initial exercise parameters. These parameters may include the initial location of all future participants, their entity types, their configurations, their doctrines and other entity type dependent parameters. The second step is to link each entity's initial parameter set (The Shell) with its driver (The Engine). The link may be defined graphically by dragging the engine icon onto a Shell or through tables, e.g. as specified herein below: The link phase may require the engine to be online. The graphical link typically causes a request from the IOS to the engine. The request carries all the parameters set in the Shell. The engine may override the request. For example, if an entity type is requested from a Computer Generated Forces server that does not know how to support some of the parameters, it may ignore them.

Exercise Building Blocks: Different Shells may be created and saved in the Shell database. Different Engines, that have logged on in the past may be saved in the Engine database. A collection of Shells, with or without their defined Engines, may be saved under the Scenarios database. Different Scenarios may be saved into Exercises in the Exercise database. Each and every building block may be edited, saved and loaded at any time except for the Exercise. This means that typically, while running an exercise, an additional scenario may be added. Shells may be added or removed, and their parameters manipulated, e.g. edited and saved. To manipulate a different Exercise the user typically must exit the existing Exercise.

A Support Section, e.g. as shown and described herein with reference to FIGS. 4A-4B, typically holds all the data which is to be used for construction and manipulation of exercises and all of its components. The support window is typically separated into two main windows, the properties window and the database window. Selection of any object in the system may display its properties through the properties window. The window is typically object type dependent and may display different information for different objects. Object Selection is typically through double clicking on it with the mouse left key. The Properties window is typically the main window through which editing different parameters is typically possible. There may be a number of different editing methods such as but not limited to selecting from pull down menus, dragging objects and dropping them at different locations, manually entering data, and selection from additional windows.

The Shell Properties window of FIG. 4A has two main areas, The Shell definition on top and the Shell properties through the different tabs. The Shell properties may be category dependent. An aircraft and a SAM may have totally different property editing tabs and windows. The Shell Definitions may include the Shell Icon which is typically displayed according to the Icon selected through the Icon Select button. Pressing the Icon Select button may open the Shell Icon list window through which a new Icon may be selected.

The Shell Name may be user defined and is typically up to 20 characters long. The Shell Category describes the type of entity to be used such as but not limited to Aircraft, Helicopter, SAM, AAA, Tank, Truck, and Soldier. The Category option includes an edit option which opens a Category edit window.

The Shell Type is typically Category dependent. Each category may have a number of different types, for example, The Aircraft type may for example include Air to Air, Air to ground, and multi-role. The Shell type includes an edit option, which opens a Shell Type edit window. Pressing the Comment Button opens a Comment editing box.

The Shell Initial Tab typically is associated with some or all of:

(a) A Shell Call Sign which may be up to 10 characters long. A call sign formation number may also be selected. The available selections may be 1 through 9. The default call sign number is typically 1.

(b) A Shell Team which is typically a pull down and may, in the illustrated embodiment, be green, red or blue.

(c) Shell Status which sets the startup status of the entity. The options include: Engines on, Engines off.

(d) Shell Start and End time which define when the participant may join the exercise and when it may exit. Marking the arrow box may set the time boxes to activate, otherwise no time dependency is typically required.

(e) Shell Latitude and Longitude: The Shell Position is typically initially empty (e.g. grayed out). The position in the two boxes is typically in geographical coordinates (WGS-84). Each parameter is typically provided with 7 digit accuracy (XX:XX:XXX—hour:min:decimal).

(f) Entering position coordinates: Once coordinates are entered, the shell is typically converted to a disabled participant. The coordinates may be entered using any suitable method such as: (1) Through dragging and dropping the shell onto the map; (2) Through manually entering coordinates and pressing apply; and/or (3) Through selecting a position from the pull-down menu and pressing apply.

(g) Shell Altitude: The altitude type includes three options: AGL (Above Ground Level); ASL (Above Sea Level); and On ground. Selecting On ground may gray out the altitude box. The altitude units may be according to the system section. (feet or meters).

Shell Heading: The Heading of the Shell is typically in degrees and ranges from (001-360). The Heading is typically True and not magnetic.

(i) Shell Velocity: Units may be m/s, Km/h, Knots, etc.

Optionally, a Shell Mission Tab, Shell Systems Tab and Shell Configuration Tab are provided.

The Engine Properties window of FIG. 9 typically comprises:

(a) The Engine Icon: The Icon displayed is typically according to the Icon selected through the Icon Select button.

(b) The Icon Select button. Pressing the Icon Select button opens the Engine Icon list window through which a new Icon may be selected.

(c) The Engine Name. The Engine name is typically up to 20 Characters long.

The default name is typically the name received from the engine source; and

(d) The Engine Capacity. The Engine Capacity may either be manually entered or received automatically from the engine. The numbers may for example range from 1 to 999 where 999 means unlimited.

Pressing the Comment Button opens a Comment editing box.

The default Shell tab holds the default shell linked to the engine if it is dragged and released on the map and not on a Shell. Pressing the Select Shell button switches the Data base window to the Shell Data base.

Selecting a default Shell: Dragging a Shell onto the Shell display in the Engine Properties window may replace the old default shell with the new dragged shell. If a default shell has not been selected for an engine, the shell display in the engine properties window may remain empty. Dragging and dropping an engine, for which no default shell has been defined on to the map may not be possible. A message may prompt: “A default Shell has not be defined for the engine”, and the Engine properties window may be displayed with the default Shell tab.

The Participant Properties window of FIG. 10 typically displays both the Shell and Engine data. Typically, the Shell data is a combination of the Shell definitions with the actual updated participant information. For example: The Lat/Lon displayed may be of the current location and not empty. The configuration may be of the participant and not of the original shell. The Call Sign at the top left is typically according to the definition in the Shell parameters. The Call Sign cannot be edited through the Left top display but only through the Shell data.

The Shell section typically holds the Shell name and the Shell icon. Both the Shell name and icon are typically not editable through this window. Single clicking the Shell name or icon may display the Shell data tabs below. The tabs may be the same as in the Shell properties window, however the top definitions may remain the participant definitions. Double clicking the Shell icon may switch the Participant Properties window to the Shell Properties window.

The Engine Section holds the Engine name and the Engine icon. Both the Engine name and icon are typically not editable through this window. Single clicking the Engine name or icon may display the Engine data tabs below. The tabs may be the same as in the Engine properties window, however the top definitions may remain the participant definitions. Double clicking the Engine icon may switch the Participant Properties window to the Engine Properties window.

The Editing Tabs in the Participant properties windows may be either in the Shell mode (default) or in the Engine mode. All the operations, available in the tabs when under the Shell or Engine Properties window, may also be available here. Changes to parameters may update the shell/engine connected to the participant and therefore update the participant itself. For example: entering a new location in the Shell initial tab and pressing apply may update the participant location.

New Shell or Engine Selection: Dragging a Shell from the Shell database tab and dropping it on the shell icon, in the Participant Properties window, may switch all the current participant definitions to the new shell definitions, except for the current location which may remain the same. Dragging an Engine from the Engine database tab and dropping it on the Engine icon, in the Participant Properties window, may switch all the participants Engine to the new selected Engine.

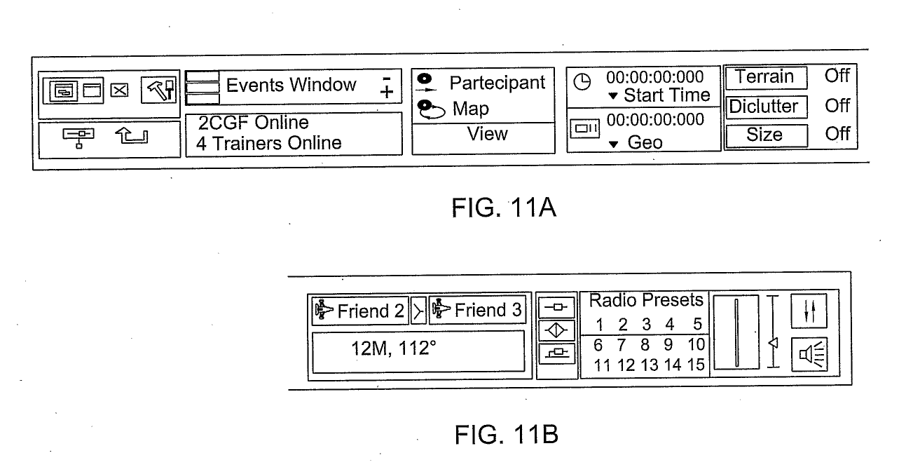

According to certain embodiments of the present invention, a “map section” display may be provided e.g. as shown in FIGS. 11A and 11B taken together. The Steer point, as illustrated in FIGS. 11A-11B, may display the current center of the map only when no mouse cursor is typically over the map. When a mouse cursor is over the map\small map it may display the current steer point of the mouse cursor. To Display in UTM\Geo: Toggle between UTM\Geo by clicking once on the Geo \UTM title. The title may change accordingly to Geo \UTM. To effect manual steer point insertion, double click on the steer point field may open edit box for manual steer point insertion. After pressing Enter, the current map center may change to the new steer point. When pressing enter, all tracked participants may become untracked. It is optionally possible to “freeze” the current steer Point in which case no functionality may occur.

A Measure tool provided in accordance with an embodiment of the present invention typically comprises two drag areas which participant and Steer points may be dragged to. After being dragged to the two areas, the relative details may be shown. When the right click menu is typically opened after right clicking on the map, an option: “Add steer Point to relative tool’ may be shown in the menu. After choosing that option the steer Point may be added to the relative tool (to the free side or to the left side as default).

Buttons provided may comprise: reset the tool, toggle between the two sides, and Save\load the settings via dialog box.

A Time display may display time and may be toggled to four types of time by press a button: GPS time, Greenwich time, Local time and Sim time which may be the default. Each time type may be followed with the relative label next to it.

General buttons\Monitors on the Full screen may comprise a button which, when pressed, causes the map area to be shown all over the screen. The map center may remain the same. The Toolbar, participant and preparation section may hide.

Another two-position button or switch may have a first position in which the map toolbar may remain and a second position in which the view may revert to the normal mode.

A display area may display the number of online Computer Generated Forces\Mission Training Center and the number of entities from each.

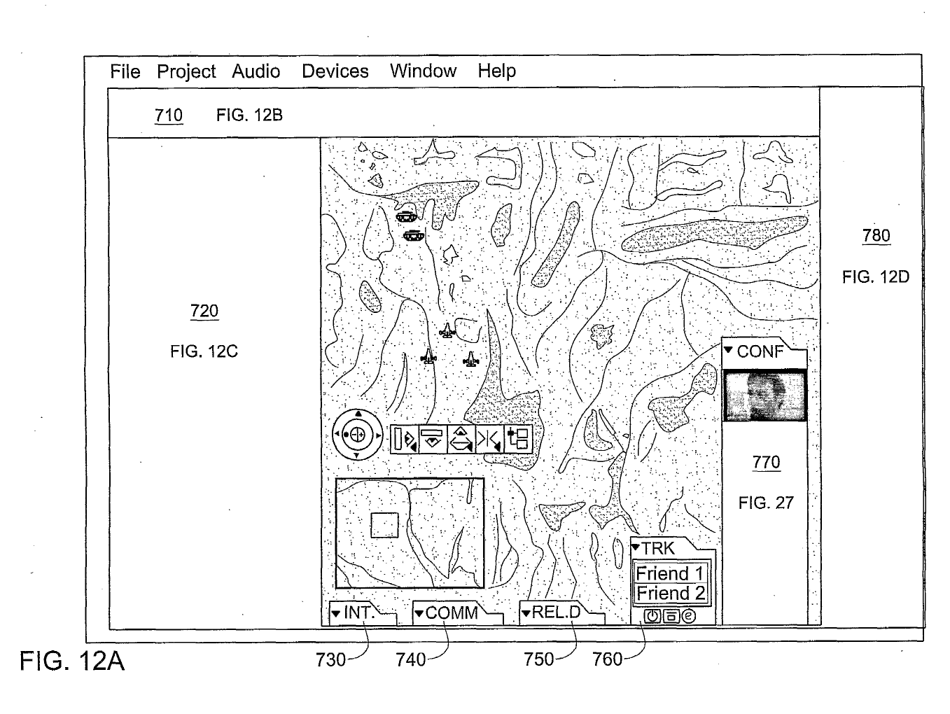

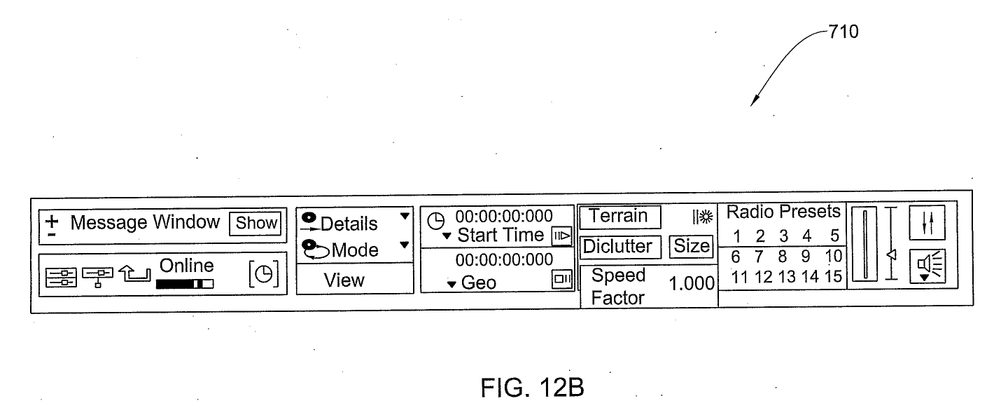

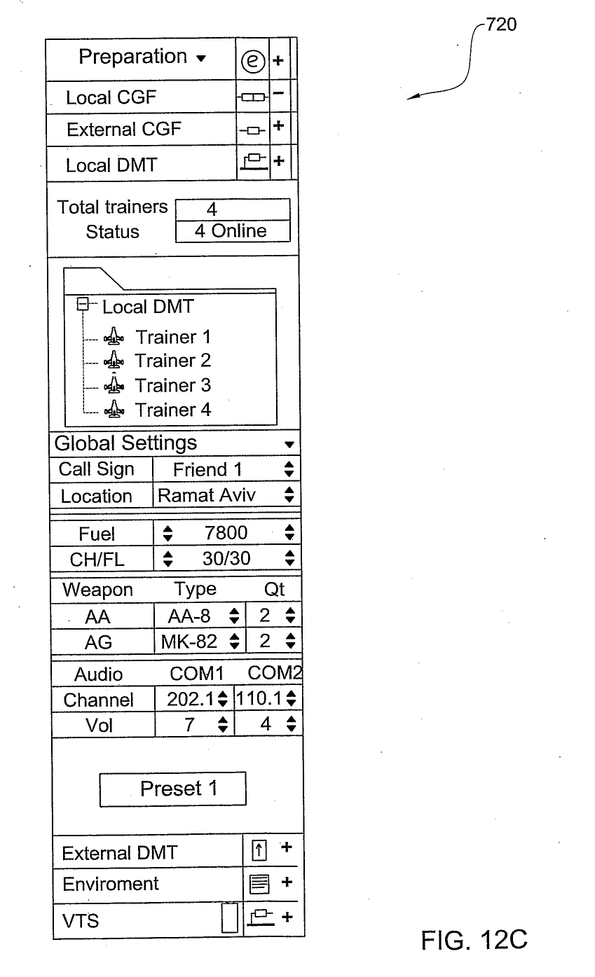

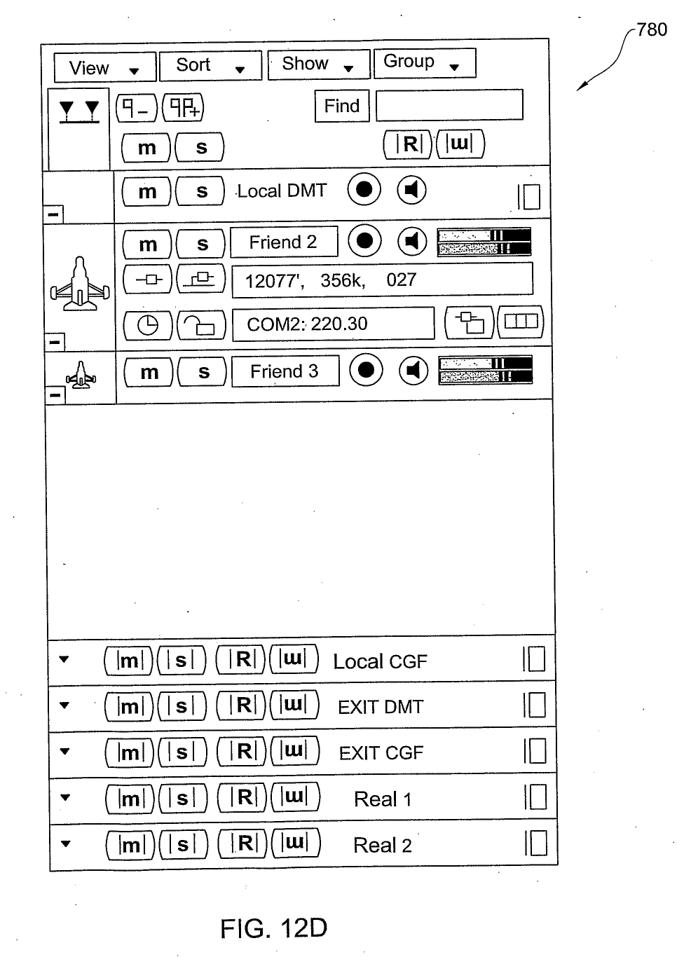

A Map is typically displayed by the system as shown in FIG. 12A. Typically, drop zones are included in the screen display of FIG. 12A. For example, the drop zones shown may include any or all of the following:

a. An “Int” zone 730, shown closed, providing intercom communication between participants dragged and dropped into this zone, typically both among themselves and with the instructor.

b. A “Comm” zone 740, shown closed, providing another mode of communication between participants dragged and dropped into this zone, typically both among themselves and with the instructor.

c. A “Trk” zone 760, shown open, providing tracking of participants dragged and dropped into the zone. Typically, a participant is tracked by maintaining it at the center of the map by translating the map according.

d. A “Conf” zone 770, shown open, providing video and/or audio conference capabilities between instructors, an embodiment of which is shown in detail in FIG. 27. Dragging and dropping an icon, such as an instructor from an external (remote e.g.) computer generated force, into the Conf zone causes a conference to be opened between that remote instructor and the user as shown in the example of FIGS. 26-27. Typically, the remote instructor dragged into the Conf zone can be both seen and heard by the user who may be the instructor of “local CGF”. The icon of the remote instructor is typically dragged from its normal location e.g. within the “external CGF” area in the control panel 720 of FIG. 12C.

The display of FIG. 12A also includes controls, e.g. a top control panel 710, a right control panel 720, a left control panel 780, embodiments of which are shown in detail in FIGS. 12B, 12C and 12D respectively. In FIG. 12C, entities are shown, such as Trainers 1-4 which are the names of four shells, three of which are shown on the terrain, the fourth being absent in the illustrated example. Clicking on these entities typically results in a display of their respective properties. In FIG. 12D, properties of a particular engine, called Friend2, are shown open.

According to an embodiment of the invention, operation manager apparatus is provided for a simulative training system. The apparatus includes a user interface, including a display screen, e.g. as shown in FIG. 12A, allowing a manager to manage the simulative training system including defining at least one typically virtual (not real-life) object having at least one property. The user interface has a drag and drop functionality operative to allow a user, such as an instructor or object or participant or human-operated workstation associated with, e.g. controlling, an object, to draft and drop at least one virtual object into a zone on the screen and, responsively, to cause the zone to assign to objects placed therewithin, at least one object property such as but not limited to a communication or armament property of an object, previously defined for the zone.

For example, the manager (or other user) may define one or more virtual aircraft objects, employing various communication channels respectively, the identities of which channels are stored as respective properties of the respective virtual aircraft. The objects may even have no channel defined. The manager or user has a communication channel of his own. The drag and drop functionality allows the virtual aircraft to be dragged into a defined “communication zone”. Once this has been done, the manager, merely by actuating a transmission option (e.g. by pressing a transmission button) can communicate with all virtual aircraft in the zone, all necessary technical preparations and particularly changing the channel properties of all aircraft in the communication zone to match the channel of the manager, having been effected in the background, transparently insofar as the manager is concerned. In this case, the communication zone may be said to have acquired, as a property, the communication channel which is being used by the user.

In another example, the manager (or other user) may define one or more virtual aircraft objects. The user interface may facilitate acquisition, by the zone, of an “armament package” defined by the user. For example, the zone may acquire a particular armament package defined by the manager-user for F-16 aircraft, which may include appropriate numbers of several different kinds of missiles. The drag and drop functionality allows a virtual aircraft object to acquire the particular armament package simply by being dragged into the “armament zone” in which the armament package has previously been defined.

The technical operations allowing the drag and drop operations described above to occur may be based upon a suitable commercially available software package such as Strive-Comms 1.3 with its associated AIB hardware, commercially available from CAE Inc., 8585 Cote-de-Liesse, Saint-Laurent, Quebec, Canada.

Typically, the screen display of FIG. 12A also leads to display of Object properties. For example, selection of any object in the system may result in a display of its properties through the properties window. The window is typically object type dependent in that it displays different information for different objects. Typically, shell properties are displayed. For example, the following Shell properties may be displayed:

Shell Name—My F-16, Shell Category—Aircraft, Shell type (Category dependent)—Fighter Air to Air, Comment—free text, Shell Call Sign—Alfa Fox, Shell Team—can be green, red or blue, Shell initial Status—Engines on,

Shell Start and End time—08:00:00 11:30:00, Shell Latitude and Longitude—0032010, Shell Altitude—4000, Shell Heading—210, Shell Velocity—400, The Shell Systems (FCR, RWR, . . . ), and Shell Configuration (Fuel, weapons . . . ).

According to an embodiment of the present invention, the display of FIG. 12A may be employed to populate shells with engines. For example, a user may select an engine (e.g. by clicking on the local CGF zone and selecting, say, a particular aircraft-type “engine” or tank-type “engine”, and drag and drop that selected engine onto any shell, such as any of the 3 aircraft and 2 tanks shown in the illustrated example, in which case, the dragged and dropped engine will become associated with that shell, thereby to generate a participant comprising a shell populated by an engine. Any suitable mechanism may be employed to allow shell characteristics to be displayed; for example, right-clicking on either of the 2 tank shells shown in the illustrated example may result in the characteristics of the tank shell being displayed.

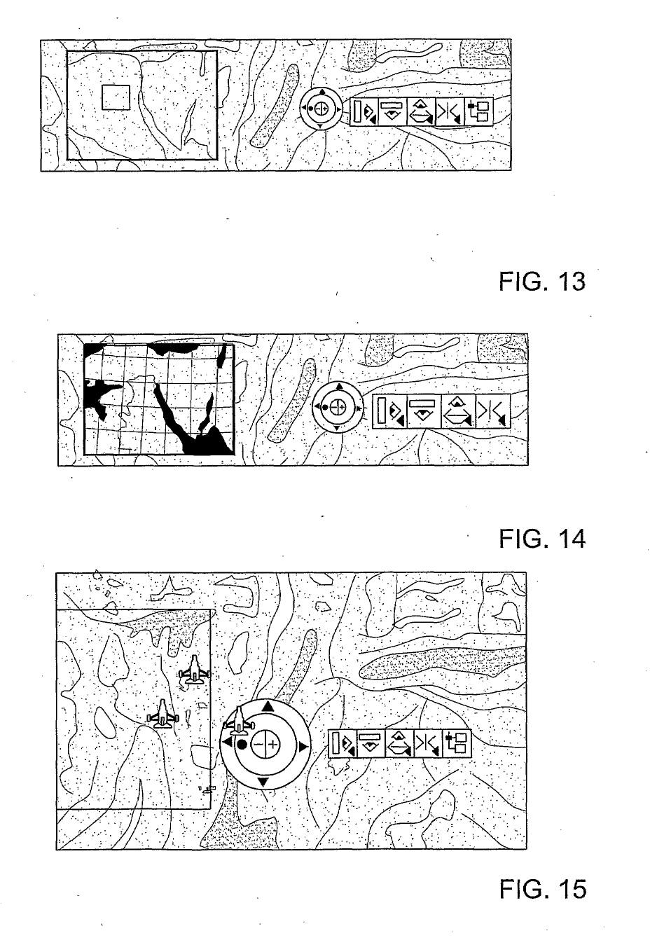

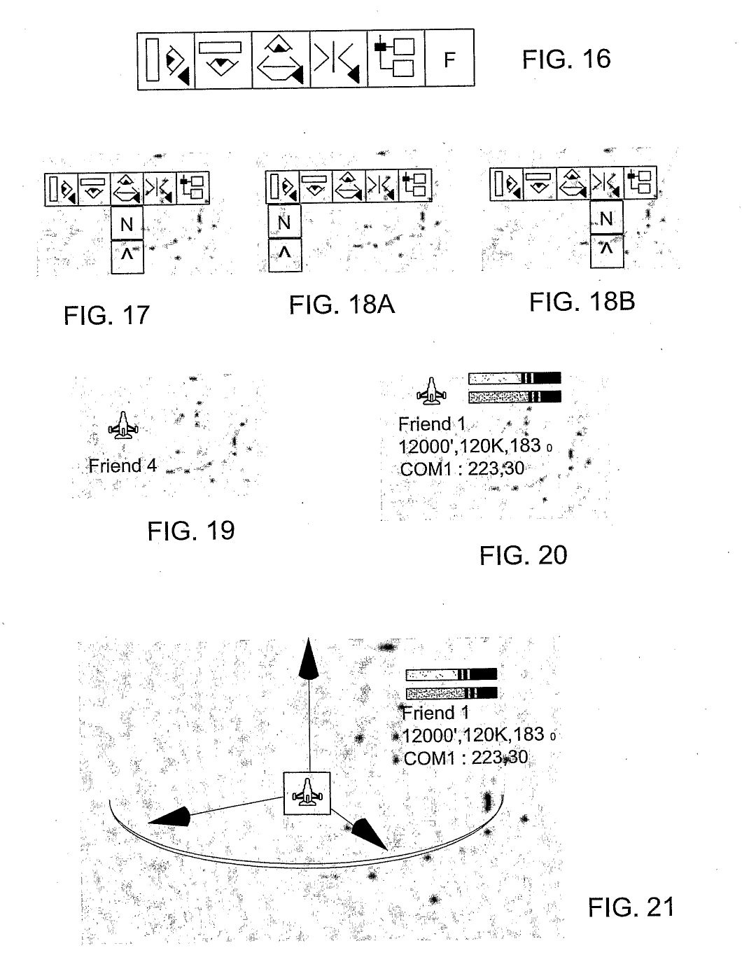

Any object shown above the map (except the participants) may be shown in semi-transparent mode as default as shown in FIG. 13. When the mouse overrides, the object may be shown in solid mode as in FIG. 14. When a participant position is under the semi transparent map object, the participant may display above the map as in FIG. 15. Map view options may be controlled by button as shown in FIG. 16. All view target is typically on the tracked participant or last centered point. All buttons except the last (right) may be check toggle buttons, not momentary. Buttons functions may include: (a) Horizontal view; (b) view from below; and/or (c) Eagle view (from top)

A sub menu may be provided as shown in FIG. 17, the options including: “3D terrain” and “Scanned Map”. A button may be provided to open a “favorites” menu. An “Add to favorite” option may add the current camera position to the favorite menu, and may open “new name dialog”. A “Remove from favorite” option may remove a favorite item from the menu after showing the list of the favorites. A “List of the favorites” option may, when choosing one of the favorites, cause the camera position to be loaded. This list may include a default item, which may be the exercise initial view.

Camera heading (when relevant) may remain the same heading as in the last view. Default heading may be north. After clicking on the Horizontal, and the 45-degree view a sub menu may be shown to choose from (FIGS. 18A-18B). Heading north is one possibility in the illustrated embodiment, and Heading 90 degrees to the nose of the tracked participant, from the nearest side to the nearest view, is typically another possibility. If more then one participant is tracked, this option may be disabled.

For all the Map view options described above, the distance between the Camera and the tracked object\point of interest may be set automatically to a suitable value.

A Participant view list may comprise a Drop list with checkable items such as some or all of: Call sign, Height xx, Radar lock, trail path, out of map participant. A Map view list may comprise a Drop list with checkable items such as some or all of: bulls eye, bulls eye Grid (for 2D only), scale signs, restricted areas, flying area. A Hide terrain button (toggle) may Hide\show all signs or Limit participant symbol size. A four-directional Map navigation button may be provided.

The default view may include a Participant map Symbol (in the relevant color green\red\blue. It may include also the call sign only if the call sign view option is pressed.

In FIG. 19, the Mouse over participant\details button in the participant block is pressed and may display with the semi transparent black frame. The frame may show in a “fade in” mode and may hide in a “fade out” mode and may include the three text fields as shown in the participant block.

In FIG. 20, a selected participant mode is shown, reachable by one click \double clicked\focus in the participant section. The mode may be entered also via double click on a suitable symbol. In this case, the Details button at the participant block may be pressed in. Upon deselecting the participant (e.g. by clicking again with the mouse) the details button may be pressed out unless it was pressed in before the selection.

FIG. 21 shows various movement tools, according to one embodiment of the invention.

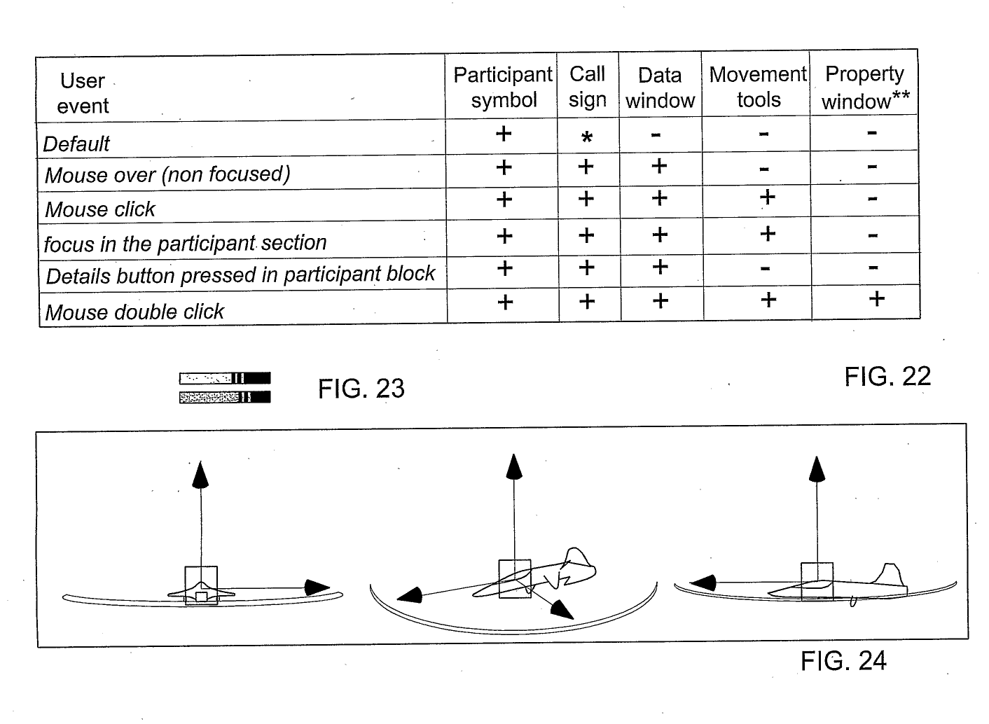

A Summary table for the participant view is shown in FIG. 22. An asterisk indicates that the relevant field in the table depends on the show\hide call sign button. The color (green\red\blue) of the Symbol may be set from the Participant preparation window.

An Energy Bar (FIG. 23) displays the energy as in the participant sector. Data displayed may include: First line: Call sign; Second line: Height, Velocity, Heading; and Third line: As defined in the participant sector.

A Communication health, commanded request Symbol (only) may flash at a suitable rate when not in 100% readiness.

A Trail path may be displayed after the path of the participant, in the participant property window.

As shown in FIG. 24, dragging a participant directly to the Small map may move the main map to the specified location and the participant as well. Dragging is typically effected by dragging one of the axes (x, y, z) or the rotation ring. The movement may occur on the dragged axis only. A details window with the destination position \horizontal distance \height \heading \aspect may be displayed next to the participant during the dragging.

Until the end of the dragging, the ghost may appear in the previous position and a line may connect the ghost and the current symbol. The ghost and the connecting line may disappear after the dragging. The symbol might flash in case the participant is not ready in the new position.

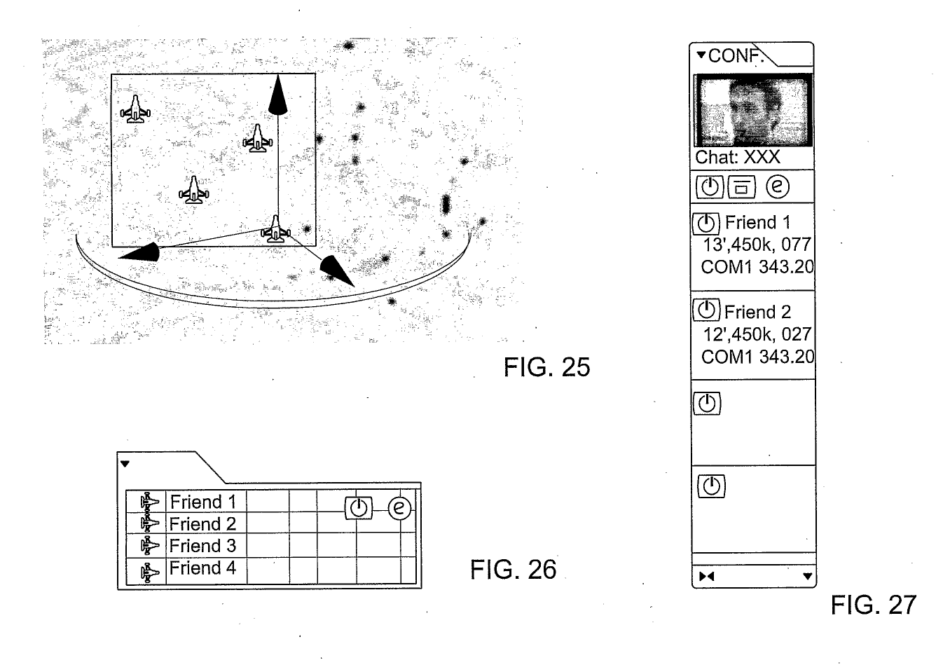

Selecting more than one participant by dragging the mouse\multiple selection on the participant section may create a group of participants Multiple selection is typically available also by CTRL+Click on the desired participants. CTRL+Click on a participant already selected may deselect the participant as shown in FIG. 25.

When a participant is out of the map area, it may be displayed as a suitable icon. It may also be displayed at the intersection of two lines: The line connecting between the map center and the participant; and the relevant Map borderline. The right click menu and a Right click on a participant symbol may lead to the view \details menu as described in the Main toolbar. The Create and save current steer Point may save the current steer Point. A dialog with the new name may be open. The saved steer Points may be displayed in the steer Point group under the Participant section. The steer Point may be displayed on the map area with a suitable Icon.

Drop zone: A “drop zone” is an area in which soldiers or supplies may be dropped e.g. parachuted. The view of the drop zone may be minimized. The data view for the drop zone is shown in FIG. 26. When the mouse is over the minimize view the drop Zone may grow into the Data View. When mouse is not over the data View the drop Zone may grow smaller into the Minimize View. When pressing the Lock button, the view may remain in the Data View. When pressing the Clear button, the drop zone may be cleared.

Responsive to right clicking on one of the Drop Zone participant text Field, a menu may be open. The menu may include the DELETE option. When the delete option is clicked upon, the participant may be removed from the Drop Zone.

Dragging: When dragging more then 4 participants to the Drop Zone, a scroll bar may be shown. An optional Full view is shown in FIG. 27. After double click on the minimize\Data view the drop Zone may grow into the Full View. After double clicking on the full view, if the lock button is in (anywhere in the drop Zone) the drop Zone may grow smaller into the Data View. If the lock button is out (anywhere in the drop Zone) the drop Zone may grow smaller into the Minimize View. After a click on the full view minimize sign, if the lock button is in (anywhere in the drop Zone) the drop Zone may grow smaller into the Data View. If the lock button is out (anywhere in the drop Zone) the drop Zone may grow smaller into the Minimize View.

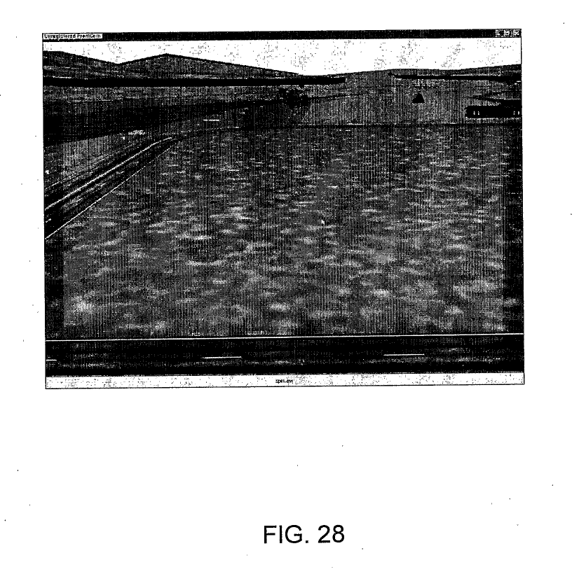

3D Navigation: All 3D navigation may be a combined press of Mouse+CTRL key or by buttons on a Toolbar. After pressing the CTRL, the mouse icon may be suitably changed. The Camera line of view may be controlled by the mouse left click+CTRL key, and may typically, be available only when the Map is not in a Track mode. Double click on the picture, e.g. FIG. 28, to play.

Camera position: X, Y axis may be controlled by the mouse right click+CTRL key. Double click on the picture to play. Z axis may be controlled by the mouse roller+CTRL key.

### Double Click on the Picture to Play

All controls described above may be functioning even when the mouse is out of the map or on the screen border (when trying to drag the mouse outside the screen).

All mouse control (described above) may be available also by buttons control in a Toolbar.

The mouse icon may be changed according to the current mouse functionality. Icons may include: (a) spin map, in free camera mode (no tracked object); (b) warp map, in free camera mode (no tracked object); and (c) move camera position, in track mode.

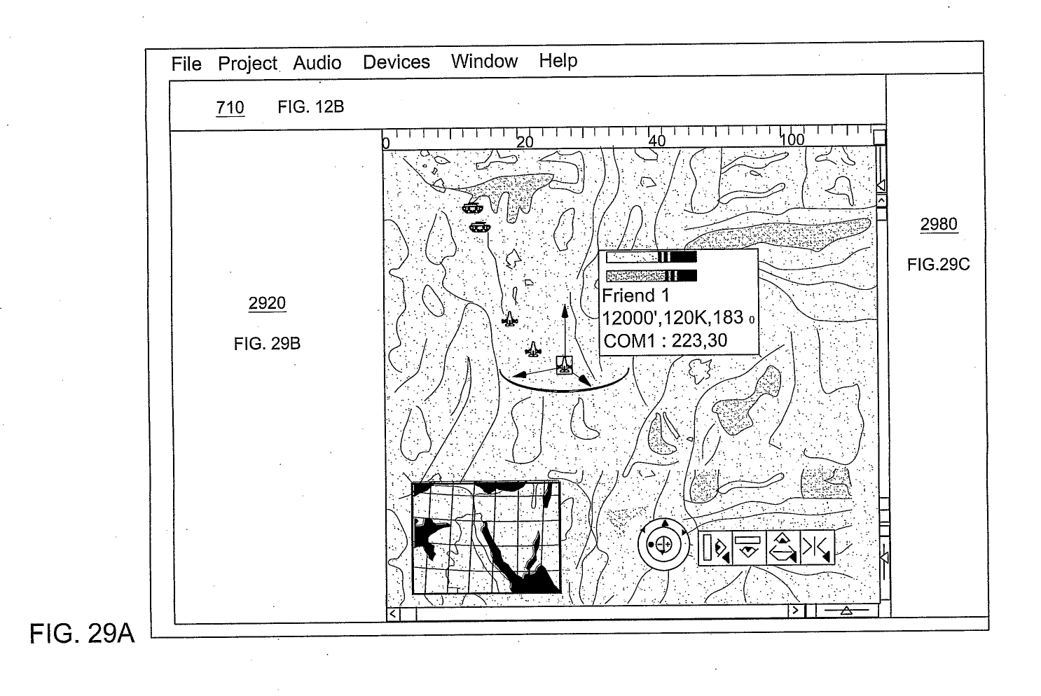

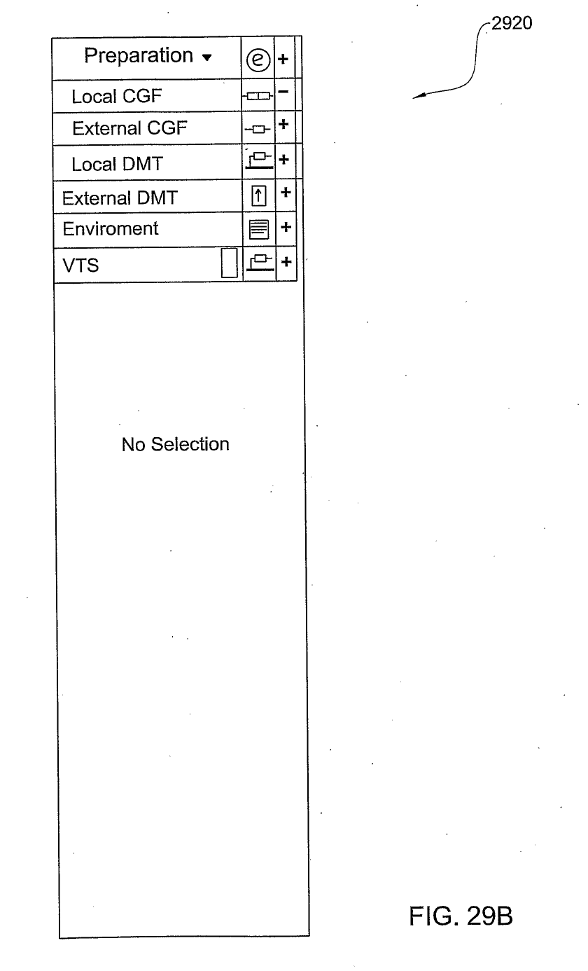

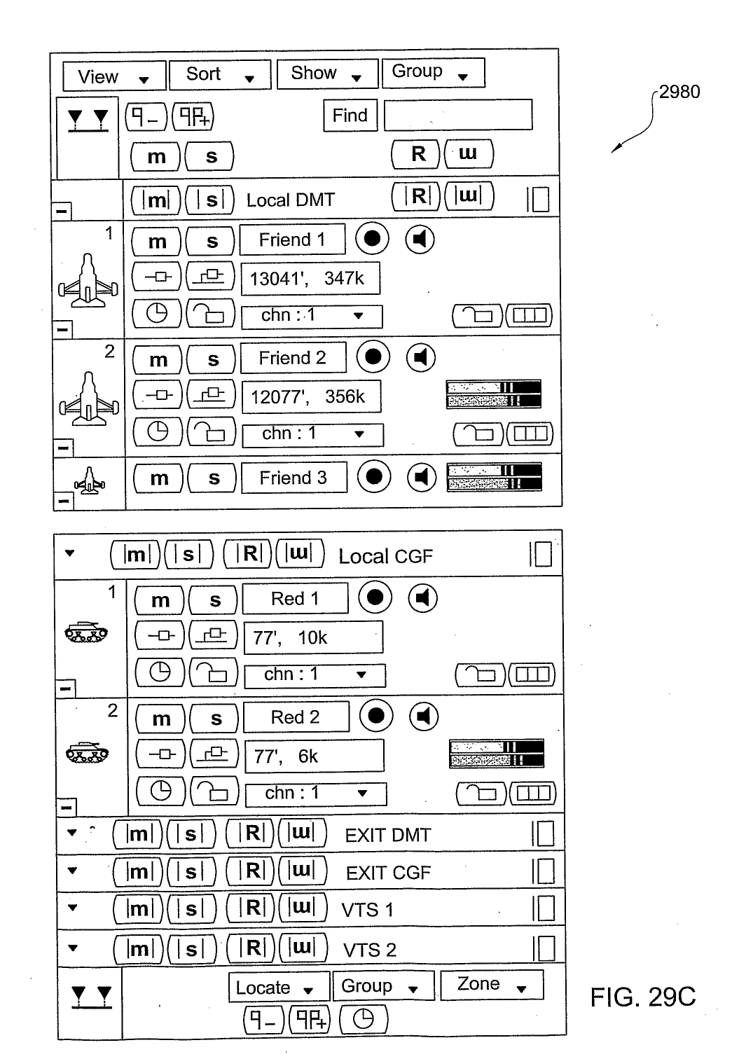

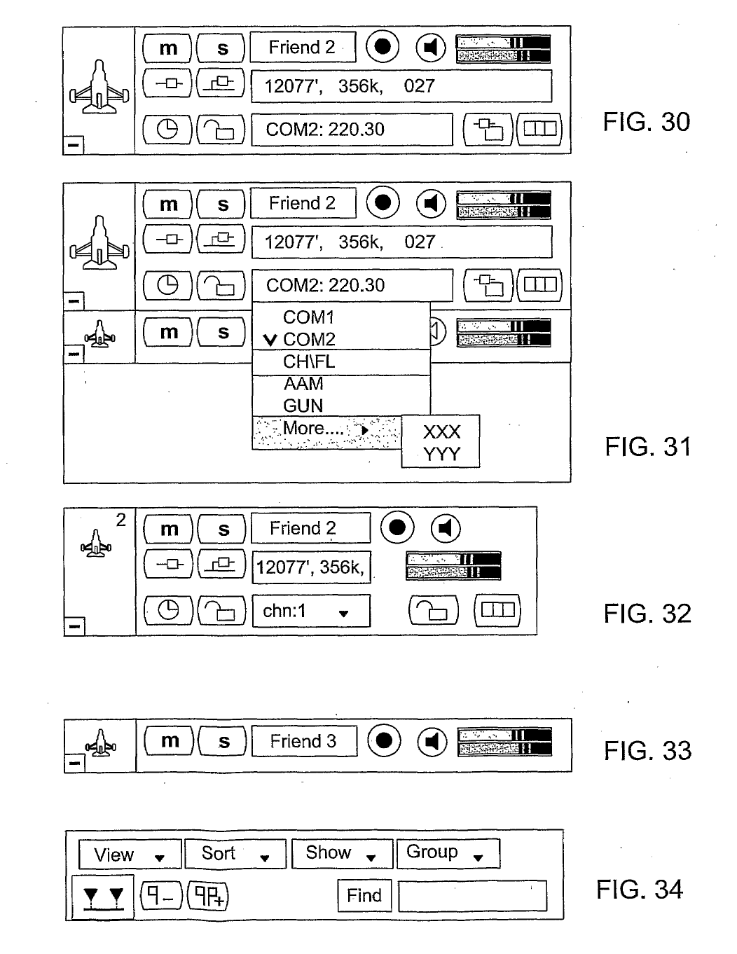

A Single participant—maximized view of a map is shown in FIG. 29A. Embodiments of the control panels 710, 2920 and 2980 in FIG. 29A are shown in FIGS. 12B, 29B and 29C respectively. The display of FIG. 30 may be shown after click on the “Minus” sign. A participant symbol color may be defined in the preparation stage. (green\blue\red). Centering the map and starting to track the map on the participants may be accomplished by a Toggle pushbutton (not momentary). Showing hook details on the map area next to the participants may be accomplished by a Toggle pushbutton (not momentary). Enable “Take control” on the participants may be accomplished by a Toggle pushbutton (not momentary). Activation\deactivation of the participants may be accomplished by a Toggle pushbutton (not momentary). Locking the participants view on Maximized mode may be accomplished by a Toggle pushbutton (not momentary).

A first text field may comprise a Call sign. A second text field may comprise heading, velocity, height of the participant. A third text field may comprise a drop list field and may be defined to display the field from a list of options by clicking on the field as shown. FIG. 31 illustrates the list details e.g. CH\FL, COM1, COM2, AA missiles, guns. After clicking on the option from the list, the relevant option may be displayed at the field.

In one embodiment, a green and blue display bar is shown, the Green portion designating engine communication health, where Full corresponds to healthy, and Blue designates request status, where Empty corresponds to “no request” and Full corresponds to the request being almost completed. Minimum values may be at the left side of the bar and the bars may be shown divided into four sections by black lines.

Another alternative for the energy bars is as follows: In the green and blue display bar shown, Green designates velocity (min 0, max 600 knots) and Blue designates height (min 0, max 50000 feet). Minimum values may be at the left side of the bar and the bars may be shown divided into four sections by black lines.

A participants' configuration button may open a configuration window. This button may comprise a Toggle pushbutton (momentary). Centering the map on the current participant may be accomplished by a Toggle pushbutton (momentary). This may disable all the Tracked participants. Enable\Disable of audio via intercom may be accomplished via a Toggle pushbutton (not momentary). A control option may be provided to set the audio transmit to the COMM1 channel of the participant. In case of multiple participants, the radio transmit may be clicked, and the shared radio channel may be chosen (COMM1\COMM2). This may be affected by a Toggle pushbutton (not momentary).

Clicking on the participant block (all around) may mark a participant as being in focus as shown in FIG. 32. CTRL+Click may add another participant to the focus participants and subtract a focused one. SHIFT+Click may add all the in between participants to the focused participants. Double click may open the configuration window.

Single participant—minimized view may be displayed as the default participant view as shown in FIG. 33. Pushbuttons may behave the same as in the maximize view, as shown above. Clicking on the participant block (all around) may mark the relevant participant as being in focus. A double click may maximize and set a participant in focus.

The Data Control Menu shown in FIG. 34 may provide control which holds the same functions in the database section as in the participants section. Specific functions which are disabled may be shown as grayed out.

Views may include: (a) Expand all—expand all the participants to maximized view. Expand is typically disabled in the Shell database; and/or (b) Collapse all—collapse all participants to minimized view. Collapse is typically disabled in the Shell database.

The Sort control may allow sorting (a) By name—in which case the group headers may remain, and the objects inside each group may be sorted according to their name; and/or (b) By Energy in which case the group headers may remain and the objects inside each group may be sorted according to their energy. The By Energy function is typically disabled in the Shell database.

“By groups” may be the default option. In “By colors”, the group headers may remain. The objects inside each group may be sorted according to their teams, green\red\blue. The “Show” control may allow selection of “All” in which case the group headers may be removed and all the objects may be displayed in one header. Sort is typically also available on the all display. If “Group” is selected, the objects may be displayed in the groups type display. When adding a new participant, the participant may be added to a default group as default in which case, typically, a default group may be created.

The Group bar may have two display options: The Participant display option as shown above and a Database display which is typically similar but doesn't have the command buttons. After focusing on some objects and select the group>new, a new group may be created at the bottom with the objects. The group may be in a different color. The name for the group may be defined after the creation by typing the text into the group heading which may be changed also later by a double click on the name. The default name may be “user defined 1”. Only user defined groups may be removed by focusing on the group heading and choosing the remove. This feature is typically enabled only if the Show>by groups is chosen.

Finding: After typing the name/call sign and clicking “find”, the objects found (all names/call signs that start with the typed text) may be expanded and focused. All other pre focus objects may be unfocused. When changing between the all the view\sort\show options while objects are in focus it may remain in focus unless it is typically not included in the new view\sort\show option.

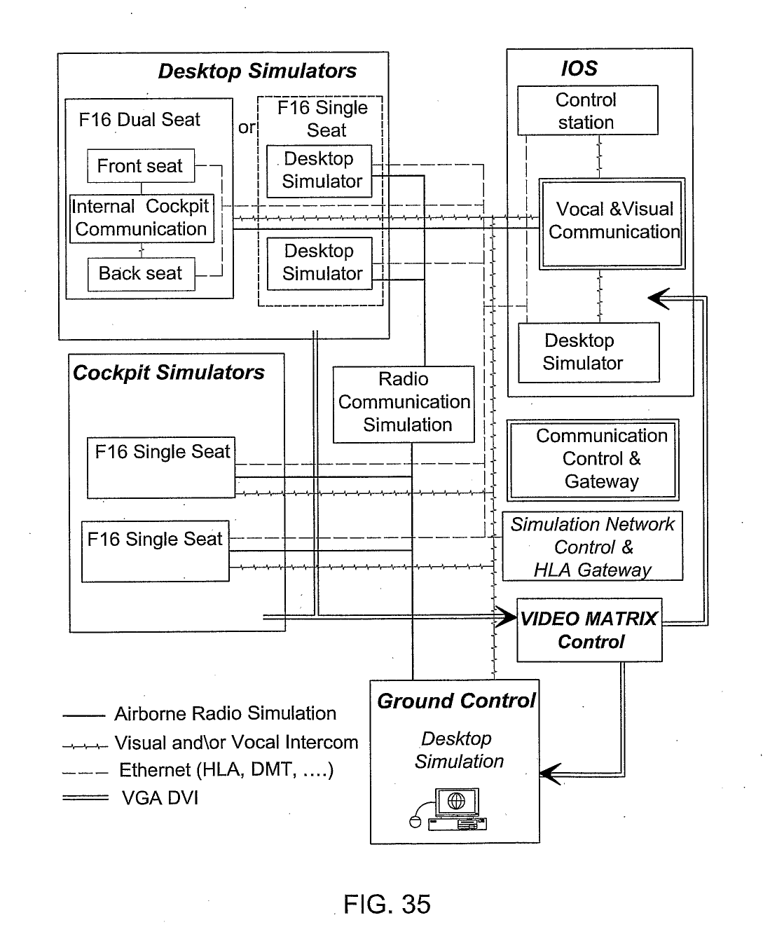

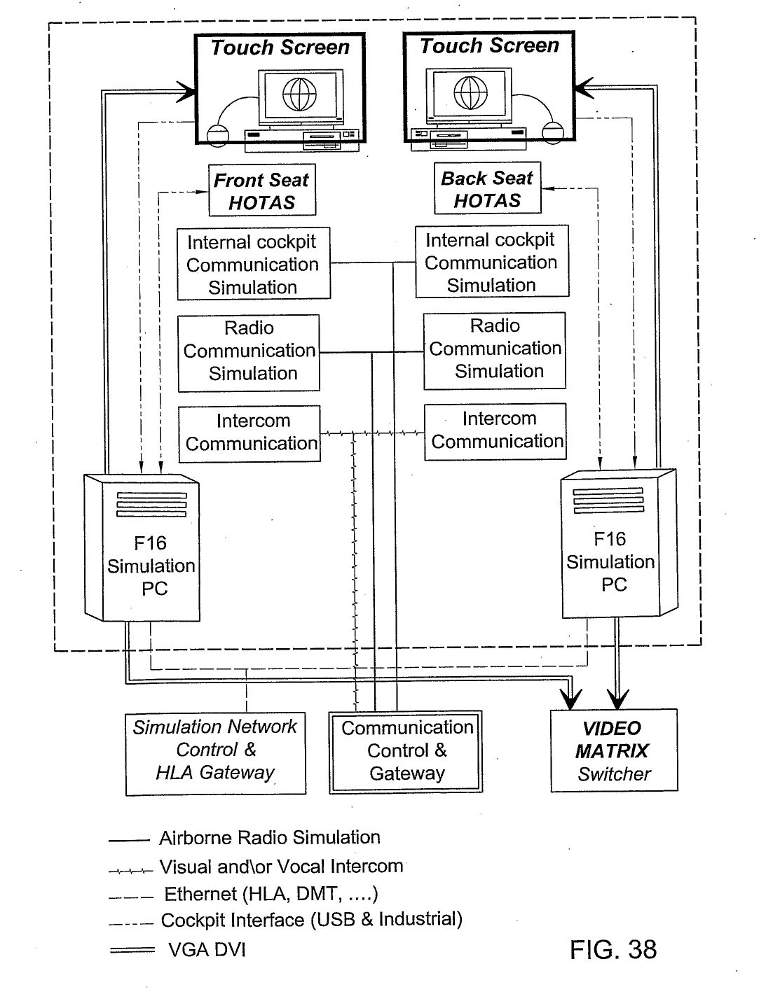

With reference to FIGS. 35-55, elements of a Distributed Mission Operation (Mission Training Center) Instructor Operator Station (IOS) constructed and operative in accordance with another embodiment of the present invention, are now described. Some or all of these features may, if desired, be combined with some or all features of the system shown and described herein with reference to FIGS. 1-34.

FIG. 35 describes the Mission Training Center architecture according to an embodiment of the invention. The mission of the Mission Training Center is to support a large joint training exercise that is executed without burning any fuel, without firing any real ammunition and without any wear and tear on the aircraft. In this exercise, pilots and navigators fly over enemy territory without restriction and in any weather conditions. They have the capability to return to any point in the exercise and restart, and afterwards they can review all aspects of the mission in a comprehensive electronic debrief. This training takes place without the pilots ever leaving their home duty stations.

In this environment, the pilots fly in high-fidelity simulated crew stations with correlated real-world sensor and visual databases. They interact seamlessly with other manned and sophisticated computer-generated participants over high-performance networks.

One, some or all of the following users may operate and train in the Mission Training Center:

(a) Instructor—operates the IOS. The system can be operated by a single instructor or two instructors.

(b) Trainees—can be pilots, navigators or Ground Control operators. The trainees are trained in their stations and are debriefed using the debriefing station.

(c) Debriefing Station Operator

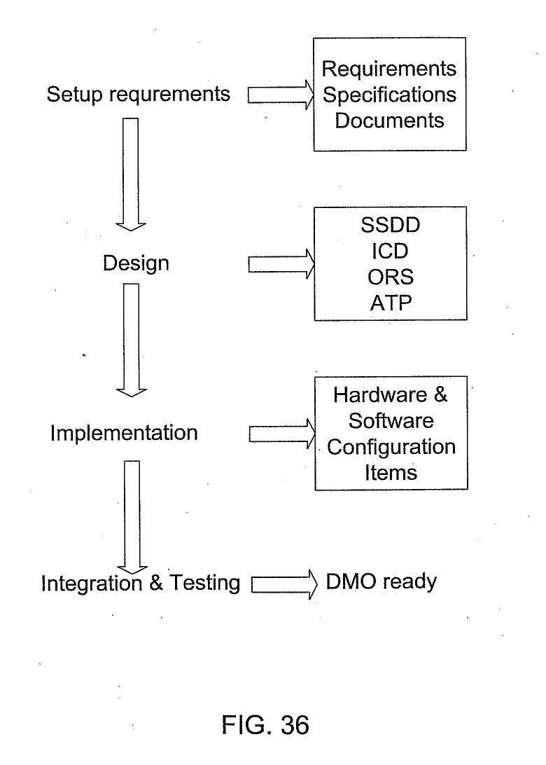

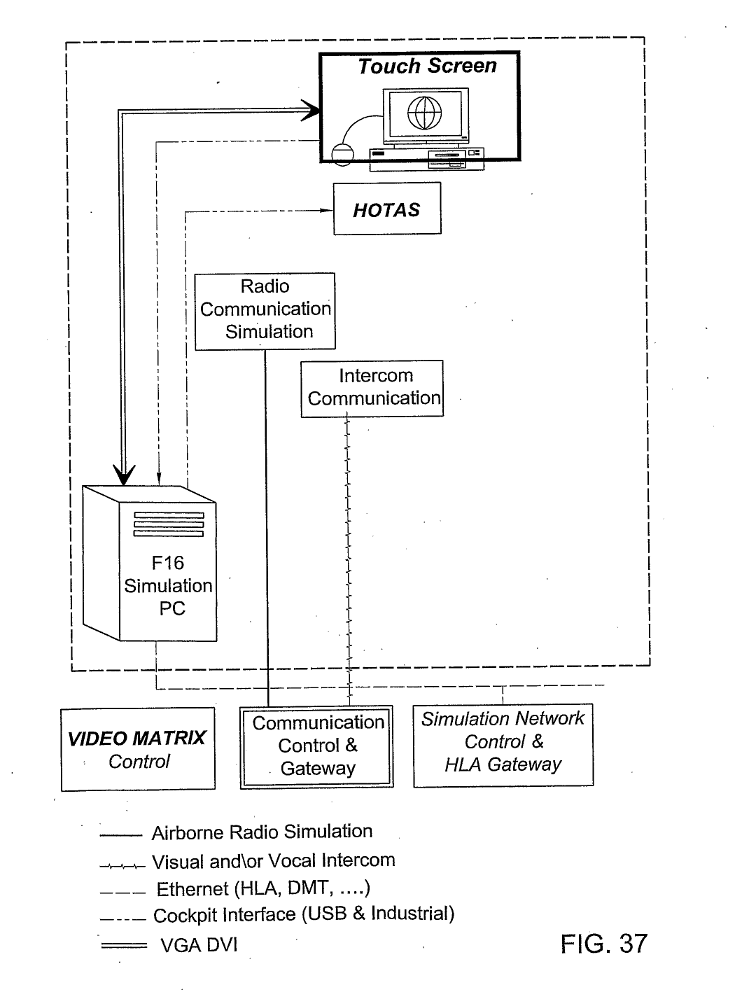

The development process in the DMT project may be as described in FIG. 36.

The aircraft selected for the DMT may, for example, be F-16. For F-16 aircraft, simulation may be performed by Airbook. As a rule, all HW and SW modules that are not directly related to F-16 are typically reusable. That way, it would be relatively easy to replace the F-16 with a different aircraft.

High Level Architecture (HLA) is architecture for reuse and interoperation of simulations. The HLA is based on the premise that no single simulation can satisfy the requirements of all uses and users. An individual simulation or set of simulations developed for one purpose can be applied to another application under the HLA concept of the federation: a composable set of interacting simulations. The intention of the HLA is to provide a structure that will support reuse of capabilities available in different simulations, ultimately reducing the cost and time required to create a synthetic environment for a new purpose, and also to provide developers with the option of distributed collaborative development of complex simulation applications. The HLA does not prescribe a specific implementation, nor does it make the use of any particular software or programming language mandatory.

The first key component of HLA are the simulations themselves, or more generally, the federates. A federate can be a computer simulation, a manned simulator, a supporting utility (such as a viewer or data collector), or even an interface to a live player or instrumented facility. All object representation is contained in the federates.

Everything that can be supported by HLA may be implemented by HLA although it might be simpler and faster doing it using TCP/IP, UDP or Multi-Cast. The reason for using HLA is standardization. If “everything is HLA” it may be simpler to replace one CGF (STAGE for example) with another (STRIVE for example) or one IG (VEGA for example) with another (TILTAN for example). The DMT may comply with HLA rules.

The runtime infrastructure (RTI) is a distributed operating system for the federation. It provides a set of general-purpose services that support federate-to-federate interactions and federation management and support functions, which may be arranged in seven basic service groups as follows: a) Federation management, b) Declaration management, c) Object management, d) Ownership management, e) Time management, f) Data distribution management, g) Support services. All interactions among the federates may go through the RTI. The DMT system may be based on MAC RTI.

Prior to the development of the High Level Architecture (HLA) for Modeling and Simulation, the IEEE Standard for Distributed Interactive Simulation (DIS) defines a standard set of protocols which permitted networked simulations to interact through the common communication of simulation data. These two mechanisms create significantly different environments for distributed simulation applications. DIS combines a simple data delivery architecture (broadcast UDP/IP datagrams) with strictly controlled message format standards (known as protocol data units (PDUs) to create a system that maximizes interoperability between simulation partners. In contrast, the HLA defines robust data delivery architecture but leaves the definition of content standards to individual simulator federations.

The HLA specifies two types of object models: the HLA Federation Object Model (FOM) and the HLA Simulation Object Model (SOM). During development of an HLA federation, all federation members may achieve a common understanding as to the nature or character of all required communications among participating federates. The primary purpose of an HLA FOM is to provide a specification for data exchange among federates in a common, standardized format. The content of this data includes an enumeration of all object and interaction classes pertinent to the federation and a specification of the attributes or parameters that characterize these classes. Taken together, the individual components of an HLA FOM establish the information model contract that is necessary (but not sufficient) to achieve interoperability among the federates.

The Real-time Platform Reference Federation Object Model (RPR FOM) was designed to organize the PDUs of DIS into a robust HLA object class and interaction class hierarchy. The priorities for developing this design are, in order:

1. Support transition of legacy DIS systems to the HLA.

2. Enhance a-priori interoperability among RPR FOM users.

3. Support newly developed federates with similar requirements.

A HLA SOM is a specification of the types of information that an individual federate could provide to HLA federations and the information that an individual federate could receive from other federates in HLA federations. For SOMs, the intent is to describe the public interface of the federate in terms of an identified set of supported HLA object classes and interaction classes. A SOM describes salient characteristics of a federate to aid in its reuse and other activities focused on the details of its internal operation. As such, a SOM is not the concern of the RTI and its services. A FOM, on the other hand, deals with interfederate issues and is relevant to the use of the RTI.

To maintain interoperability, all sub-systems that connected to HLA may use as a basis the same RPR-FOM 2.0D17. The system may be able to handle changes in the RPR-FOM that may be made during the development process. If due to development constrains different FOMs are used, there will be need for an exchanger that will convert data formats of one FOM to another.

The system is typically able to use one of the CGF systems: CAE STRIVE, STAGE.

The system is typically able to use one of the IG systems: VEGA PRIME, TILTAN.

The goal is to have a real Ground Control Station hooked up to the system. The architecture below describes an alternative solution.

The MALAM Debriefing Station is typically used as is. The radio/intercom capabilities of that station are typically analyzed and if they do not meet the requirements, the MALAM Debriefing Station is typically modified.

Entities that may take part in simulations are defined herein. Each entity typically has a unique enumeration that may comply with DIS standards.

The DMT typically includes some or all of the following sub-systems (HWCI): Two F-16 Desktop Simulators that can play as either dual seat aircraft or two single seat aircrafts, Two F-16 Single Seat Cockpit Simulators, an Instructor Operation Station (IOS) that includes Operational Control, Mission planning, and Debriefing; CGF, Technical control facility that includes a communication Control & Gateway, a Simulation Network Control & HLA Gateway, and a Video Matrix Control, and a Ground Control Desktop Simulator.

The DMT typically includes the following CSCI: IOS application, Simulator application, AIRBOOK, Map Database.

FIG. 1 is a F-16 Single Seat Desktop Simulator Block Diagram, for one embodiment of the invention. The mission of the F-16 Single Seat Desktop Simulator is to enable the user pilot to participate in a DMT/DMO tactical training exercise.

The F-16 Single Seat Desktop Simulator may comprise the following components: simulator PC, cockpit, OTW and HUD displays, dome, and headset.

The Simulator PC Missions may include Simulation of the F-16 aircraft, Display driving, Receiving user inputs from the Touch Screen, and Interfacing to the F-16 HOTAS. The simulator PC may run Airbook for F-16 simulation and cockpit driver software for interfacing to the HOTAS. The Image Generator (IG) is built in the Airbook and it updates automatically the OTW, which is combined with the cockpit image.

The HOTAS mission is to enable control of the simulated aircraft.

Touch Screen Display mission is to show the combined cockpit and OTW. The Touch Screen enables the user to operate the cockpit systems.

The earphones and microphone (headset) mission is to enable pilot voice communication.

An Audio terminal provides radio and intercom communication.

FIG. 37 is a F-16 Single Seat Desktop Simulator Block Diagram, according to an embodiment of the invention. The mission of the F-16 Dual Seat Desktop Simulator is to enable pilot and navigator to participate in a tactical training exercise as a team.

The F-16 Single Seat Desktop Simulator may comprise two F-16 Single Seat Desktop Simulators e.g. as described herein.

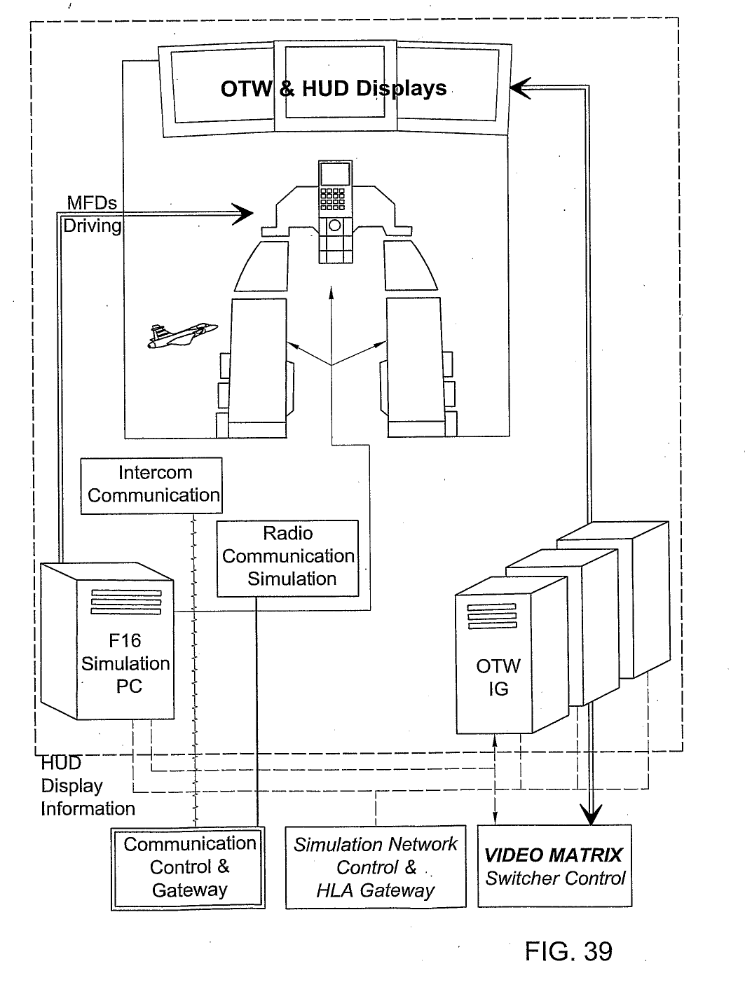

FIG. 39 is a F-16 Cockpit Simulator Block Diagram, according to an embodiment of the present invention. The mission of the F-16 Cockpit Simulator is to enable the user pilot to participate in a DMT/DMO tactical training exercise.

The F-16 Cockpit Simulator may comprise the following components: Simulator PC, cockpit, OTW and HUD displays, dome and headset. The simulator PC is typically the same as for F-16 Single Seat Desktop Simulator. In addition to its missions in the desktop simulator, it may drive the two MFDs in the cockpit and communicate to a full cockpit.

The Cockpit typically includes all the necessary hardware (switches, controls, indicators, MFDs, UFC) to simulate F-16 aircraft. The EMICSA cockpit may be used.

One of the cockpit simulators may run in a dome while the other typically has LCD OTW displays. Projectors may create the picture and screen for picture display. LCD displays and/or a HUD Combiner may optionally be provided.

The dome may comprise 8 Projectors that create the picture and screen for picture display.

The same headset as for F-16 Single Seat Desktop Simulator is typically used.

The same Audio terminal as for F-16 Single Seat Desktop Simulator may be used.

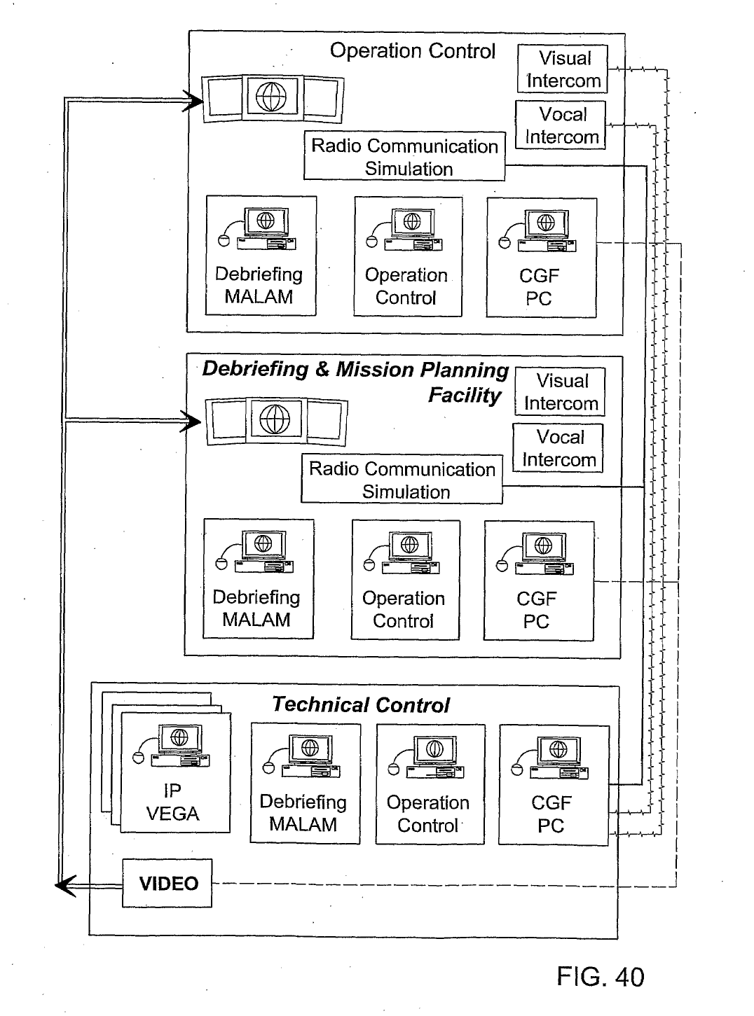

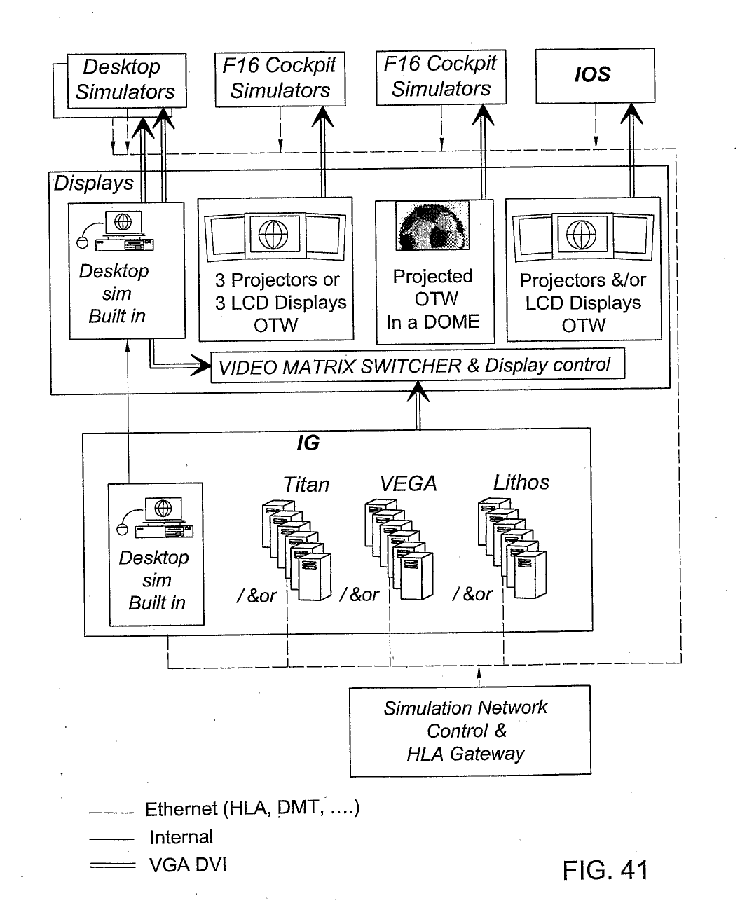

FIG. 40 is an IOS Block Diagram according to an embodiment of the invention. The IOS may have operation and control station missions, debriefing and mission planning facility missions and technical control facility missions. Suitable missions of the Operation & Control Station are detailed in the IOS OCD [document 2 referred to herein].

The tasks of the Debriefing Station may include:

(a) To enable the trainees to sit together after they perform the mission, watch the debriefing, and learn from it. In order to do this, replay of the mission may be as accurate as possible within a small tolerance. The recorded audio (radio and intercom) may be synchronized with the recorded operations performed by the trainees and the virtual entities; and/or

(b) To enable a group of people to sit together and watch and hear a mission during its operation in real time.

The tasks of the Mission Planning Station may include some or all of:

(a) To enable a user to setup, create or edit an exercise and store its local Exercises database.

(b) To share databases with the Operation & Control Station.

(c) To edit an existing exercise and all the parameters that the exercise is built from like virtual entities, environment (weather conditions), arms, weapons etc.

(c) To provide “mission loading” capabilities to the A/C (navigation, weapons, fuel, etc).

The missions of the Technical Control facility may include any or all of:

(a) To provide monitoring of the network communication by displaying all messages, trapping specific messages, providing timing data etc. The information is typically used for debugging and maintenance of the system.

(b) To provide secret information. The information is typically used for the instructor to understand the activities performed in the mission, to activate situation-dependent events, and Debugging, monitoring and maintenance of the system; and

(c) To provide “god's view” or “flying carpet view” to support the operator of the system.

The IOS may comprise the following components: Operation & Control Station, Technical control facility, and the Debriefing & Mission Planning facility. The Operation & Control Station may run the DMT. The station may comprise one, some or all of:

(a) IOS application PC—PC that may run IOS application to enable operator to control the system.

(b) CGF PC—PC that may generate run STAGE to generate CGF.

(c) Radio Simulation Control PC—PC that may provide GUI to control the radio simulation system.

(d) IOS debriefing PC—

(e) Visual system—System that may provide GUI to control video routing and generate “god's view” or “flying carpet view”. It may use a HW splitter.

(f) Communication system—The system may comprise earphones and microphone (headset) to enable voice communication and a videoconference system that is typically used for communication between instructors of different DMTs and between the DMT instructor and the Debriefing Station operator. The videoconference is typically performed using a Logitech® QuickCam® Sphere cameras and Polycom PVX™ software.

Debriefing & Mission Planning facility typically includes the same components as the Operation & Control Station but the components may be physically separated. Debriefing is typically performed in a dedicated debriefing room and Mission Planning is typically performed offline to prepare exercises and entities for future use.

The facility may comprise one, some or all of:

(a) Display control PC—A module that is typically responsible for routing pictures to monitors in the IOS.

(b) Network Gateway & Control PC—A tool that may allow network monitoring. It also typically includes a gateway that will convert the HLA to data link protocol and vice versa.

(c) Radio Gateway & Communication Control PC—a tool that may handle the radio and intercom communication either as VOIP or over the HLA. The gateway will also serve, in the future, as a pipe that will route the audio to and from the system through real radio systems to real aircrafts participating in the exercise.

(d) IG PC as described herein; and

(e) HLA PC—PC that may run RTI.

FIG. 41 is an Image Generator and OTW Displays\Domes Block Diagram according to an embodiment of the invention. The tasks of the Image Generator and OTW are to provide the pilot trainees with the feeling that they are flying a real aircraft. Several IGs may band together to create the OTW display. The number of IGs corresponds to the number of projectors and can vary according to the demo system. If the system includes a dome then there might be 7 IGs and 7 projectors. If the demo system includes 3 LCD panels then the number of IGs and corresponding projectors is typically 3 accordingly.

Every IG that creates part of the terrain is dedicated to that particular part. The IG is setup to display that part as one of the federates. The federate can be considered as a “camera” that is attached to the aircraft, moving in space with it and showing an angular part of the terrain.

IG may enable the instructor to control the exercise by providing “god's view” or “flying carpet view”.

The IG may comprise IG PCs that may run VEGA PRIME to generate an image.

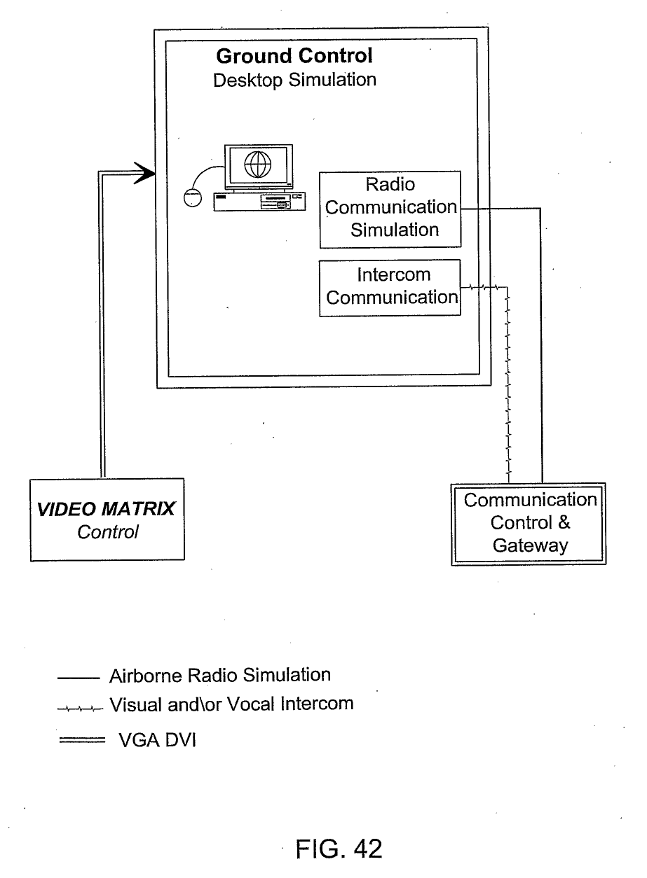

FIG. 42 is a Ground Control Station Block Diagram according to an embodiment of the invention. The Ground Control Station missions include enabling the user (Ground Control Operator) to watch the scene and provide instructions to the pilots using simulated radio comm.

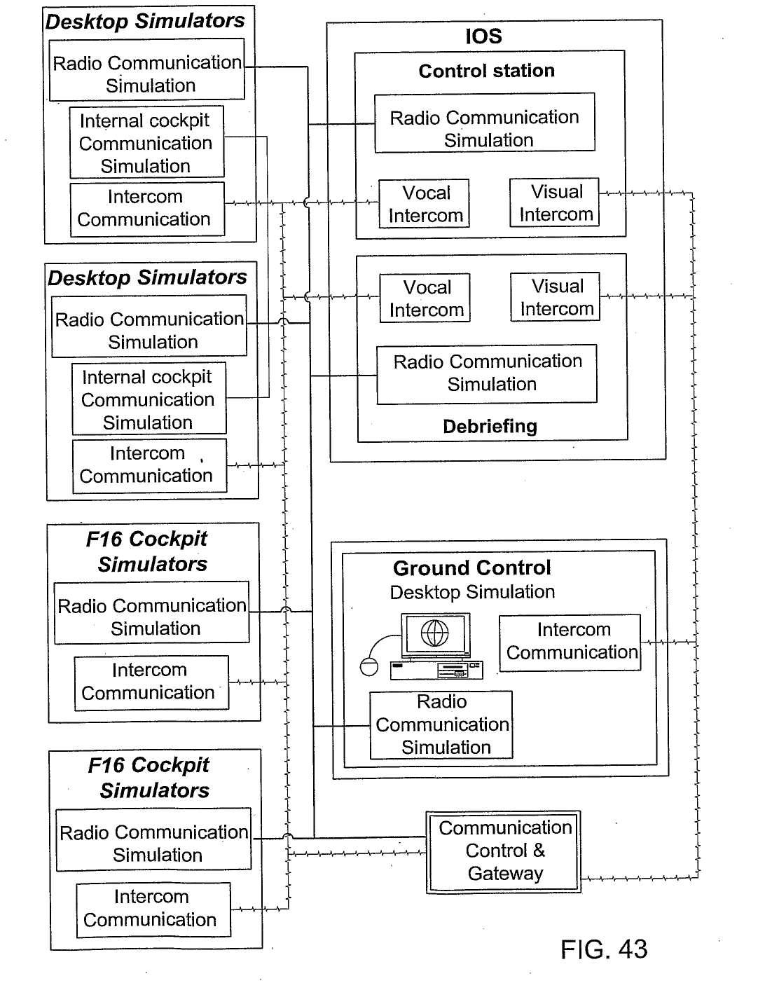

FIG. 43 is a DMT Voice & Video Communication Block Diagram according to an embodiment of the invention. Voice and Video communication system missions include provisions of the users' radio and intercom simulation.

Mission Training Center States, according to certain embodiments of the invention, are now described.

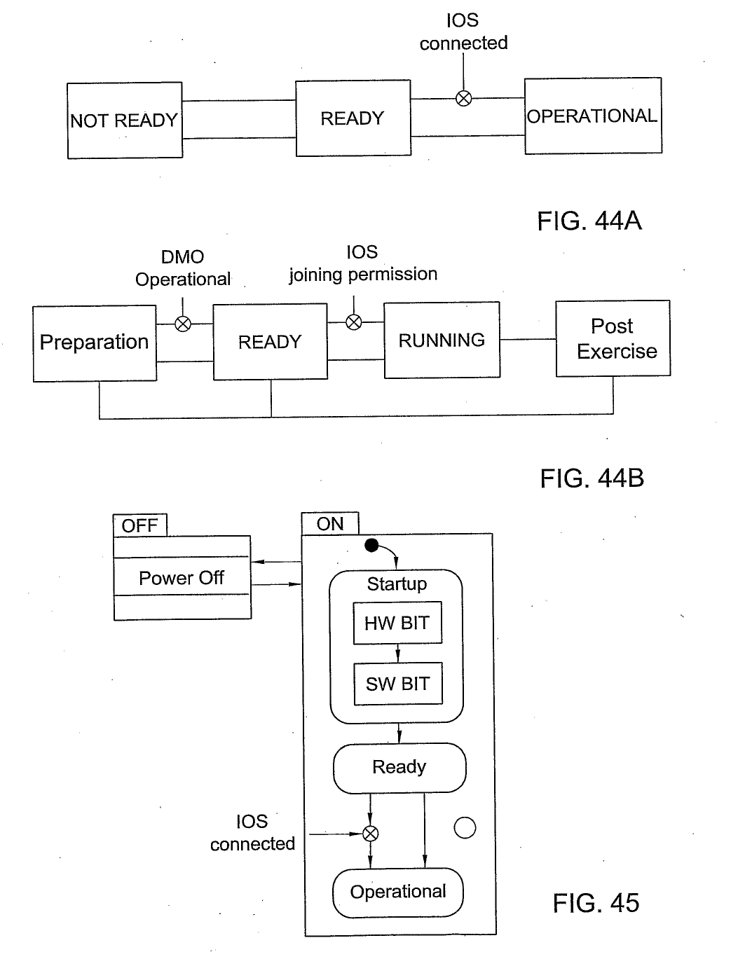

FIG. 44A is a Mission Training Center State Transition Diagram according to an embodiment of the present invention. Mission Training Center states define an infrastructure readiness for conducting an exercise. Mission Training Center is typically in Ready state when all the Technical Control facility components (HLA control, COMM control and IG/Display control) are in ready states. A Mission Training Center is typically in Operational state when the IOS is connected, the RTIExe is activated, and the Technical Control facility (HLA control, COMM control and IG/Display control) is in operational state.

FIG. 44B is an Exercise State Transition Diagram according to an embodiment of the present invention. In order to conduct an exercise, the two main components are needed—infrastructure and manager. An exercise is typically in Ready state when an infrastructure is working—Mission Training Center in operational state. An exercise is typically in Running state when the exercise manager (IOS) gives joining permission for participants.

FIG. 45 is a Control Facility State Transition Diagram according to an embodiment of the present invention. The Technical Control facility comprises HLA control, COMM control and IG/Display control. The facility is the part of Mission Training Center infrastructure which has to be in an operational state in order to enable Mission Training Center to enter its operational state. The startup state is typically entered upon systems Power-On. In this state, every sub-system of the facility may perform hardware and software initialization and BIT. Upon successful BIT completion, the facility may enter the Ready state. Transition to the Operational state is typically made upon IOS connection and RTIExe activation.

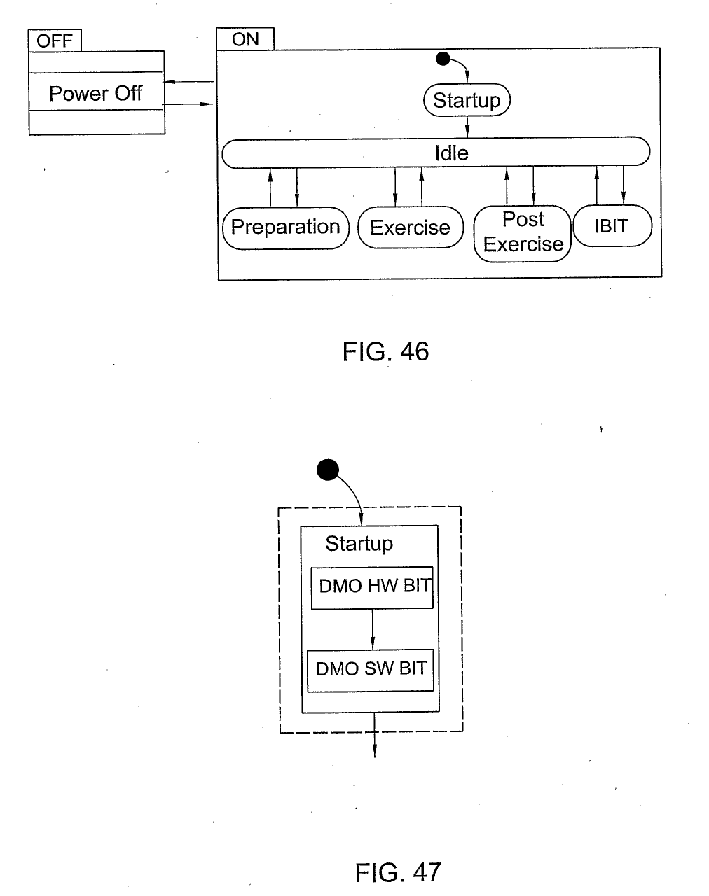

FIG. 46 is an IOS State Transition Diagram. IOS is typically able to perform Preparation and Exercise states processes simultaneously. If IOS represents DMT, it may act as a slave of Mission Training Center IOS. In that case, Simulator/CGF states diagram describes DMT IOS as well.

FIG. 47 is an IOS Startup State Diagram. Startup state entry is typically entered upon system Power-On. In startup state, IOS may perform Hardware and software initialization; and an extensive Mission Training Center Build In Test (BIT). The purpose of the BIT is to make sure that the Mission Training Center infrastructure is functioning properly. It typically includes checking of Technical Control facility functioning. BIT may include activating of RTIExe and creating a temporary federation, for instance.

A suitable Idle state is now described. An IOS may enter the Idle state from Startup state upon initialization and power-up BIT completion. Processes in Idle state may include: (a) Upon entering the Idle state, IOS may present BIT results to local display, and/or (b) In Idle state, IOS may wait for operator's command to enter one of the further states.

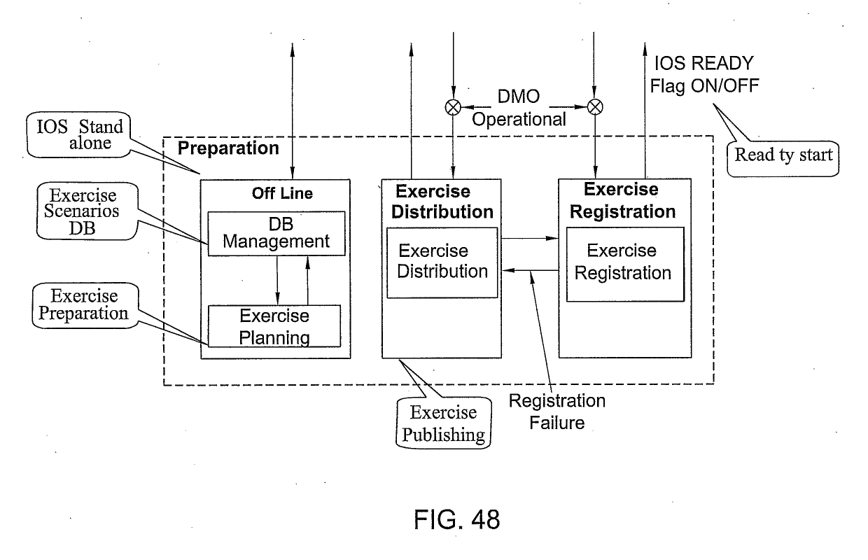

FIG. 48 is an IOS Preparation state diagram. IOS may enter/exit the state upon IOS operator command. There are typically two main modes of IOS operation while in Preparation state—off-line (standalone) and on-line (Exercise distribution and registration).

IOS can work standalone regardless to the Mission Training Center or exercise states. In order to work on-line, Mission Training Center is typically in operational state, i.e. the Mission Training Center infrastructure is typically operating. IOS may be in all on-line modes (Exercise distribution and registration) simultaneously. In some cases, IOS may perform processes of Exercise Distribution and Exercise Registration modes in off-line, without connection to the Mission Training Center. In that case, connection with an end-user is typically performed in any available way.

In OFFLINE mode, an IOS operator is typically able to perform DB management and exercise planning. IOS typically has two sub-modes to support these functions. Transition between the sub-modes is typically performed by IOS user selection.

In exercise planning sub-mode, an instructor may assign a physical PC, or group of PCs, to task shells. The term “shell” in the DMT context is defined in the reference document ORS. The SW in the IOS may delete any existing Pre Setup data if needed and validate that the essential components in the shell exist in the physical components assigned to it. The result of the exercise planning sub-mode is typically a “Ready” or “Error” message displayed to the instructor.

In Exercise distribution mode, IOS may give directions to all the sub-systems that need it to load appropriate setup data that is necessary to perform the exercise. See the description herein of Scenario Data for a fast prototype for description of necessary data that is typically loaded.

Processes in Exercise Registration mode may include any or all of the following: The IOS may perform necessary actions to get the simulation exercise ready. If an exercise registration problem occurs (such as lack of component, loading problem), the subsystem may report to the IOS and it may return to Exercise Distribution mode. IOS may consider exercise registration completed when the entire minimum set of sub-systems has successfully completed the loading and reported it to IOS. The minimum set is a set that comprises an entity that enables training. The set may be different for each exercise and is typically defined by an IOS operator. Upon exercise registration completion, IOS may return to the Idle state and set IOS READY flag on.

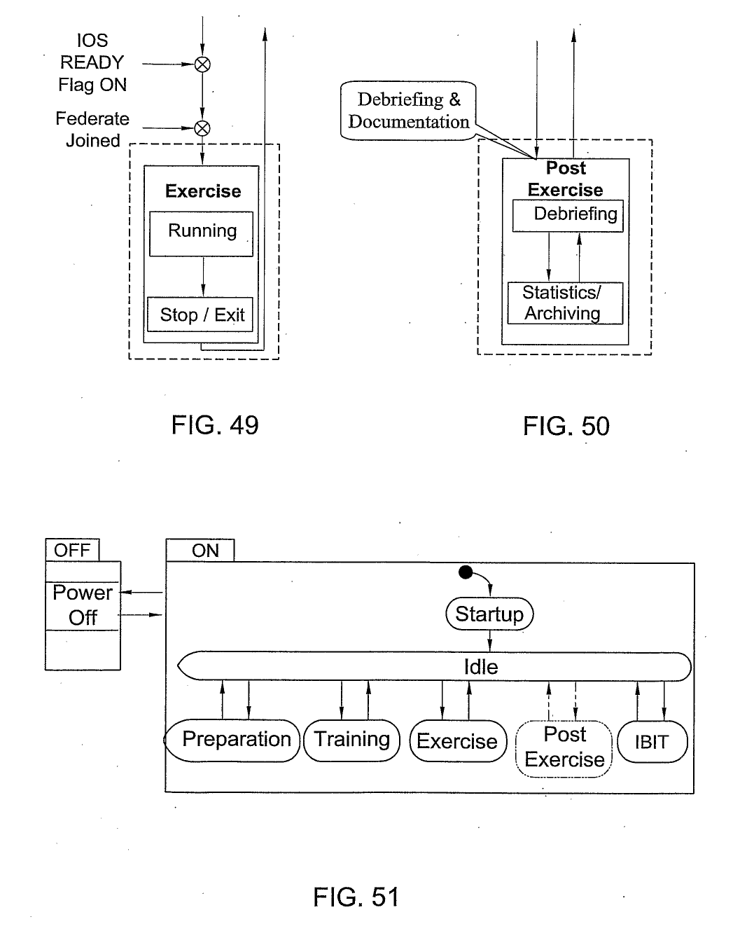

FIG. 49 is a Preparation state diagram according to an embodiment of the invention.

IOS may enter the Exercise state upon IOS operator command. Upon entry, IOS shall typically (a) Be ready to manage an exercise—IOS READY flag is typically on, (b) Create a run-time federation; and (c) Give permission to federates to join the exercise.

IOS may enter the exercise state when at least one federate has joined the exercise.

Processes in Running mode: In this mode, an exercise execution is typically performed, i.e. the actual training may take place. The IOS may perform all actions needed to manage and maintain the actual simulation process. Federates may join and resign from the federation at any stage of the exercise.

Processes in Stop/Exit mode: In this mode, IOS may perform the necessary processes to finish the exercise and return to the Idle state (DB update, saving data, etc.). IOS operator is typically able to finish the exercise at any time. The finishing process is typically performed as follows: (a) IOS application PC may notify to all participants to finish the exercise; (b) the federates may resign from the runtime federation; and (c) IOS application PC may kill the runtime federation.

FIG. 50 is a Post Exercise state diagram according to an embodiment of the invention. IOS may enter/exit the Post Exercise state upon IOS operator command. The IOS is typically able to perform debriefing of performed exercises. Processes in Statistics/Archiving mode may be performed.

Initiated System BIT state entry: IOS may enter the Initiated System BIT state upon IOS operator command. In Initiated System BIT state, the IOS may perform BIT of Mission Training Center infrastructure same as in startup state. IOS may exit the Initiated System BIT state upon BIT completion.

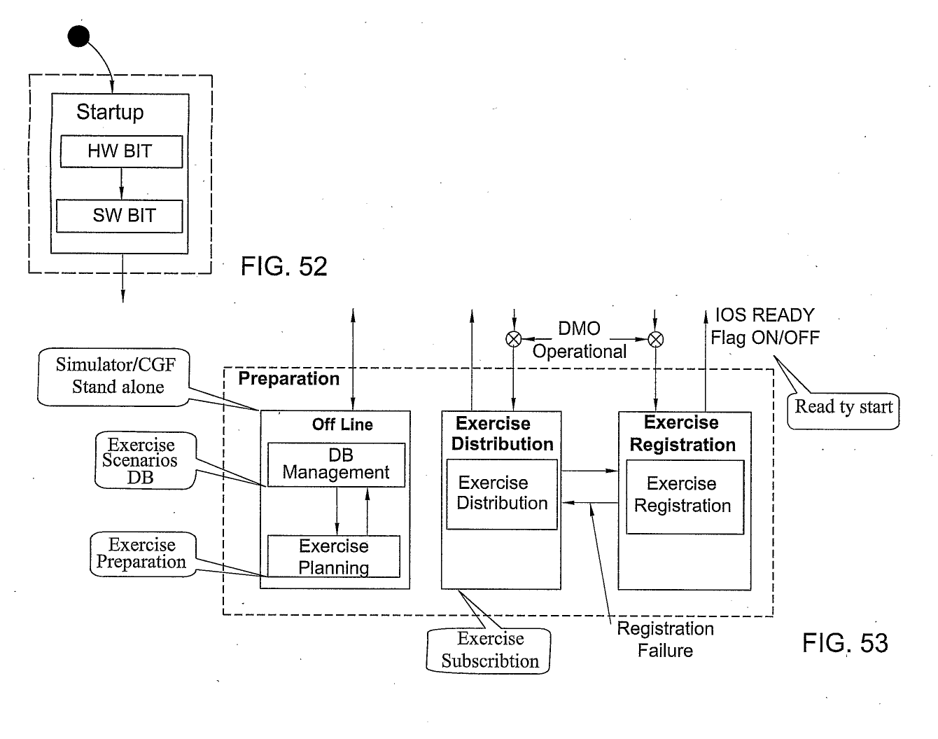

FIG. 51 is a Simulator/CGF State Transition Diagram according to an embodiment of the present invention. FIG. 52 is a Simulator/CGF Startup State Diagram. Startup state is typically entered upon system Power-On. In startup state, Simulator/CGF may perform Hardware and software initialization and/or An extensive Build In Test (BIT). A Simulator/CGF may enter the Idle state from Startup state upon initialization and power-up BIT completion. Upon entering the Idle state, Simulator/CGF may present BIT results to local display. In Idle state, Simulator/CGF may wait to command from IOS or operator or to enter one of the further states.

FIG. 53 is a Simulator/CGF Startup State Diagram according to an embodiment of the invention. Preparation state entry/exit: Simulator/CGF may enter/exit the state upon its operator command. There are typically two main modes of Simulator/CGF operation while in Preparation state—off-line (standalone) and on-line (Exercise distribution and registration). Simulator/CGF can work standalone, regardless of the Mission Training Center or exercise states. In order to work online, at least DMT is typically in operational state, i.e. the DMT infrastructure is typically in operation.

In OFFLINE mode, a Simulator/CGF operator is typically able to perform DB management and exercise planning. Processes in Exercise distribution mode: In this mode, Simulator/CGF may receive directions from IOS to load appropriate setup data that is necessary to perform the exercise. Scenario Data described herein provides a fast prototype of data that is typically loaded.

Processes in Exercise Registration mode: In this mode, the Simulator/CGF may perform necessary actions to get the simulation exercise ready and may report the IOS upon readiness. If an exercise registration problem occurs (like lack of component, loading problem), the Simulator/CGF may report to the IOS and it may return to Exercise Distribution mode. Upon exercise registration completion, Simulator/CGF may return to the Idle state and set READY flag on.

Stand-alone training state description: Simulator/CGF may enter/exit the stand-alone training state upon Simulator/CGF operator command. Processes in stand-alone training state: In this state, a simulator/CGF may perform stand-alone off-line training, regardless of the Mission Training Center state.

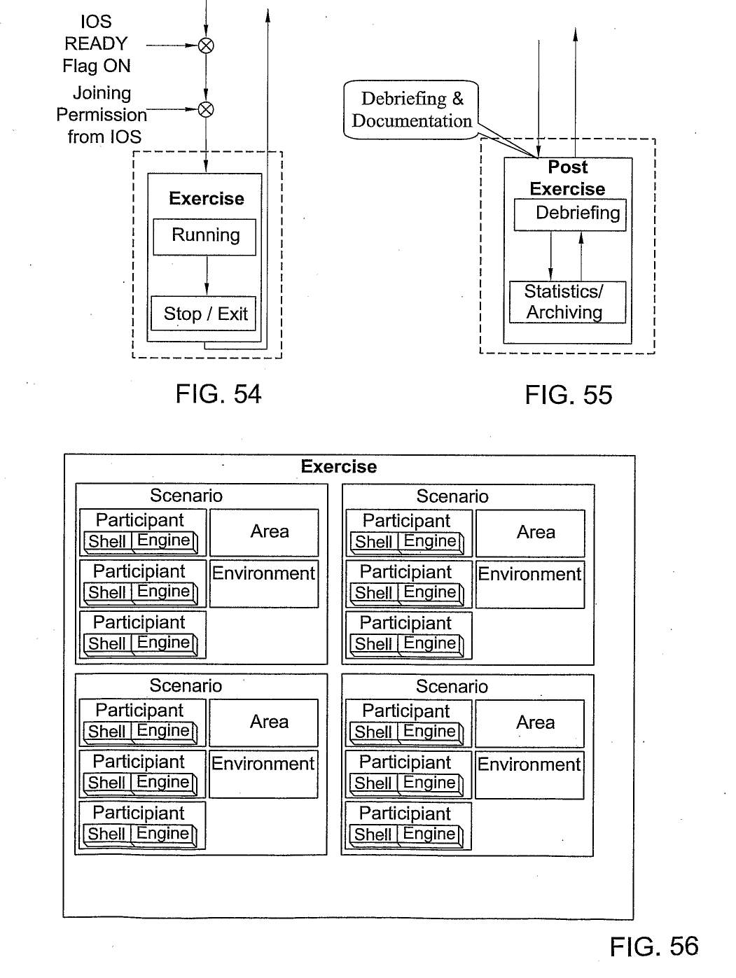

FIG. 54 is a Simulator/CGF preparation state diagram according to an embodiment of the invention. Simulator/CGF may enter the exercise state only by permission from IOS. The condition to enter the exercise is typically readiness to participate in exercise—READY flag is typically on. Upon entry, a simulator/CGF may join the run-time simulation that was created by IOS.

Processes in Running mode: In this mode, an exercise execution is typically performed, i.e. the actual training may take place. The simulator/CGF may perform all actions needed to maintain the actual simulation process.

Processes in Stop/Exit mode: In this mode, simulator/CGF may perform the necessary processes to finish the exercise and return to the Idle state (DB update, saving data, etc.). Simulator/CGF is typically able to finish an exercise by command from IOS or by simulation process result (an aircraft hits the ground, for example). When finishing the exercise, a simulator/CGF may resign from the runtime federation.

FIG. 55 is a Post Exercise state diagram according to an embodiment of the invention. Simulator/CGF may enter/exit the Post Exercise state upon IOS operator command. The Simulator/CGF is typically able to perform debriefing of performed exercises.

Initiated System BIT state description: Simulator/CGF may enter the Initiated System BIT state upon command from the IOS/local operator. In Initiated System BIT state, the Simulator/CGF may perform BIT same as in startup state. Simulator/CGF may exit the Initiated System BIT state upon BIT completion.

According to a F-16 Dual Seat Desktop Simulator synchronization-based embodiment of the invention, In order to provide realistic tactical training, the visual database of all aircrew participants (pilots and navigator) may be correlated. They may all see the same objects at the same geographical location within a small tolerance. Since each cockpit is driven by a different simulation PC, the synchronization between the simulation PCs is typically performed e.g. using conventional methods.

For the F-16 Single Seat Desktop Simulator, for the F-16 DUAL Seat Desktop Simulator, the simulator PC may continuously monitor its status and external interfaces status—(HOTAS). For the F-16 Cockpit Simulator, the simulator PC may continuously monitor its status and cockpit status. All computers that comprise the IOS may continuously monitor their own status. The CGF computer may continuously monitor its status.

FIG. 56 depicts DMT interfaces according to certain embodiments of the invention. The DMT typically has an Ethernet connection between all the PCs in the system. The Ethernet is typically used for some or all of the following: (a) HLA connection—connection between the federates. The RTI controls communication, so a protocol is not known and may remain unknown; (b) TCP/IP connection—information that will not be transferred using a HLA, is typically transferred using TCP/IP protocol.

(c) Videoconferencing—VOIP videoconferencing connection is performed using a standard TCP/IP protocol.

Video capability may be provided e.g. by means of a DVI or Analog VGA with a VIDEO MATRIX Switcher. Cockpit, HOTAS and Touch Screen may interface with the simulation PC through the USB.

Windows constructed and operative in accordance with certain embodiments of the present invention are now described, including a shell properties window, an engine properties window, an area properties window, a scenario properties window, an environment properties window and an exercise properties window.

Examples of various windows within the shell properties window are now described. The Shell Icon list window may be a scroll down window holding all optional icons. The window has select, import, remove and edit buttons. Double clicking an icon or highlighting it and pressing the select button will select the icon and close the window. The Category edit window holds a list of all created categories. Each category can be selected, edited or removed. Categories which have already been designated to items will not be removable until they are undesignated. A message of which items are still linked will be displayed.

The Shell Type edit window is a table holding three columns: The Shell Type name, The Shell Category and the Shell expected engine. Editing, adding and removing shell types is possible. The Comment editing box is a text box allowing basic editing of a comment up to 100 characters long. The Shell Mission Tab may show the same mission design tools as described above with reference to the IAI MPS (Mission Planning System) mission design. The Shell Systems Tab holds a list of all possible systems that can be installed on the aircraft. The systems, which are selected and set to enable or disable, include: AA RADAR, AG RADAR, TGT POD, RWR, ECM, ADDS, DATA LINK, UHF/VHF/HF RADIO, IFF, AAI. The Shell Configuration Tab may include the same Aircraft configuration tool as described above with reference to the IAI MPS (Mission Planning System) configuration settings.

Examples of various windows within the engine properties window are now described.

The Engine Icon list window is a scroll down window holding all optional icons. The window has select, import, remove and edit buttons. Double clicking an icon or highlighting it and pressing the select button will select the icon and close the window. The Comment editing box is a text box allowing basic editing of a comment up to 100 characters long.

The Area Properties window, according to one embodiment, is reached through double clicking the Area icon. The window contains the following editable options: Area name, Area location, Area heights, Area warnings and Area links. The Area name is 10 characters long. The Area location is set by a minimum of 3 and maximum of 10 coordinates. The coordinates can be set manually in WGS-84 or through settings on the map. The Area is set to max and min heights where 100,000′ means no top limit and Ground level means no bottom limit. Area warnings comprise a Selection of whether a warning event should be displayed is set here. The optional warnings may be some or all of: Entering an Area, Exiting an Area, Exceeding Area height limits. The Area links display a list of all scenarios that are linked to this specific Area.

The Scenario Properties window, according to one embodiment, is reached through double clicking the Scenario icon. The Area selection button allows the linkage of areas to the Scenario. A number of Areas can be attached to a single Scenario. The environment selection button allows linkage of an environment to the Scenario. One environment can be set per Scenario. A participant list is displayed in the window. Each participant may be edited through the list or through the map.

The Environment properties window, according to one embodiment, is reached through double clicking the Environment icon. Every Environment has a user defined name, e.g. up to 10 characters long. The window has three main tabs: Lighting conditions, Weather conditions, and Visibility conditions. Using the Lighting conditions tab, the default lighting conditions is set to automatic, meaning according to date and time of day. The manual lighting conditions allows either the setting of a virtual time and date through which the sun and moon positions are calculated or simply setting the lighting percentage from 0% (Dark moonless night) to 100% bright, clear sky, Sun at the zenith.

Referring now to the Weather conditions tab, the clouds settings include the amount 1/8 to 8/8, their base and ceiling in feet and their thickness in percentage. The temperature settings include the temperature on the ground and a table of temperature change according to altitude. The wind settings include the direction and velocity on the ground and a table of wind change according to altitude. Referring to the Visibility conditions tab, visibility conditions are set through visibility range in Nm. The range is the maximum range through which objects may still be identified. Two types of visibilities may be set, vertical and horizontal.

The Exercise Properties window, according to one embodiment of the invention, is reached through double clicking the Exercise icon. The window allows the selection of the required Scenarios. The Scenarios selected are displayed in the Scenario list. Only Scenarios in the database may be selected.

With reference to FIG. 56, suitable data structures useful in accordance with certain embodiments of the present invention are now described, including an exercise database, scenario database, area database, environment database, shell database and engine database. Such data structures may, for example, reside in the exercise control and database 170 of FIG. 1.

FIG. 56 illustrates an Exercise Database Structure according to one embodiment of the present invention. The Exercise database holds a list of pre-prepared exercises. Each exercise is built from building blocks called scenarios where the system holds a database of scenarios that can be attached to different exercises. A single exercise can hold a number of scenarios. An exercise can be edited at all times independent of whether the exercise is running or not. Only one exercise may be loaded and run at the same time. Exercises may be edited, loaded, saved, saved as and deleted. Editing of an Exercise is through the Exercise properties window and through the map.

Typically, the Scenario database holds a list of pre-prepared scenarios. The scenario is built of participants, areas and environment settings. Any of the scenario parts may be partially defined. For example, a scenario may be designed where all participants have a shell definition but do not, yet, have an engine definition. Scenarios may be edited, loaded, saved, saved as, deleted, imported and exported. Examples of potential scenarios include the following: “Northern SAM deployments”, “Southern SAM deployments”, “Northern Air patrolling units”, “Advanced Attacking Unit from the North”. Editing of a Scenario is through the Scenario properties window and through the map.

Typically, the Area database holds a list of pre-prepared areas. The Area is defined as the closed space between a collection of 10 points and two set heights. The points are defined through Lat/Long in WGS-84. The heights are defined in feet where an option of ground is also available. Only objects within the defined area may participate in the exercise. Editing of an Area is through the Area properties window and through the map.

Typically, the Environment database holds a list of pre-prepared environment settings. The environment settings may include: Lighting conditions, Weather conditions, and Visibility conditions. Editing of Environment is through the Environment properties window and through the map. The Shell Database holds all shell templates of all types that may be used to build a Scenario. The Shell Categories may include Fighter Aircraft, Aircraft, Helicopter, Fighter Helicopter, SAM, AAA, TANK, TRUCK, SHIP, SOLDIER, UAV. The Shell types may include: Air to Air, Air to Ground, Transport, Ground to Ground, Multi-Role, Ground to Air. The Engine database holds all engines that have connected to the Operation network.

Additional engines may be added automatically after they have been recognized by the system. Recognition occurs when the engines have come online in the HLA required standard. The engine database includes some or all of the following: Local Fighter Station 1, Local Fighter Station 2, Local Fighter Station 3, Local Fighter Station 4, Local Ground Control Station, Local CGF Server, External CGF Server 1, External CGF Server 2, External CGF Server 3, External CGF Server 4, External DMT 1, External DMT 2, External DMT 3/Station 1, External DMT 3/Station 2, External DMT 3/Station 3, External DMT 3/Station 4.

Characteristics of a fighter station 20, provided in accordance with one embodiment of the present invention, are now described.

The Fighter Station hardware for the F-16 cockpit may be purchased from the Spanish Real-Simulator company, e.g. as a level 3 type cockpit. The Fighter Station Software may be based on the Israeli Simigon Airbook builder software used to construct the required avionics. Additional Fighter Stations may be connected to the system as long as they are HLA compliant. The Ground Control Station can be of different levels, from simply using the IOS with its COMM support to using an off-the-shelf fully operating Station. Examples of such stations are the ATC PES by IAI or the ATC by NCS. All the Stations are typically compliant with the HLA.

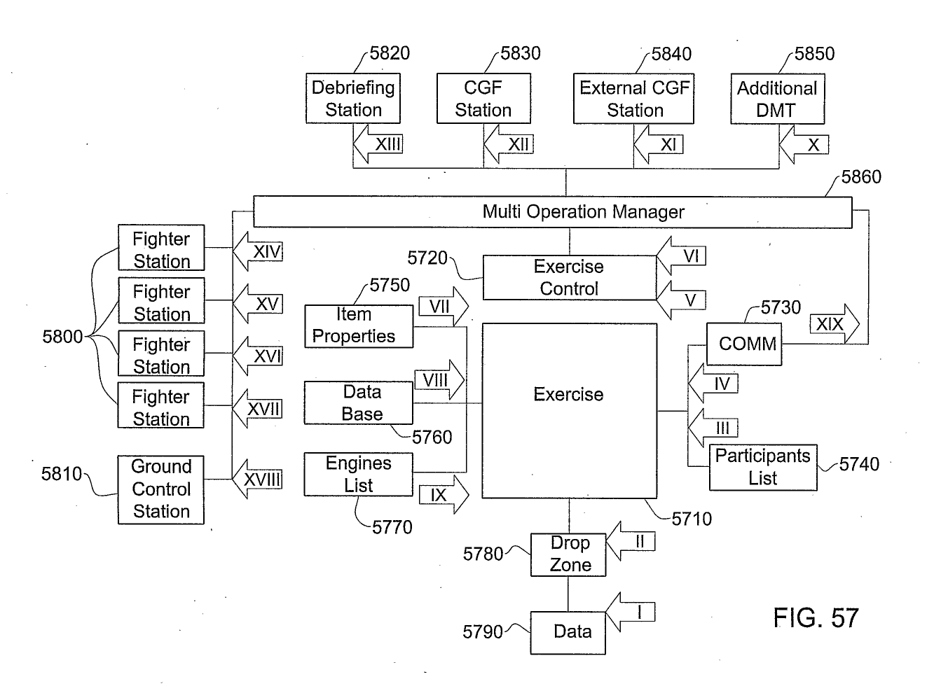

One suitable Mission Training Center Manager Architecture according to an embodiment of the present invention is shown in FIG. 57. The exercise module 5710 is the main module in which all the different events between participants occur. The exercise is displayed on a 3D map and its properties may be viewed in various ways including the participant list, engine list Data and Item properties. The exercise control 5720 is the module that contains all commands which influence the entire exercise. These commands include the play, pause and stop commands, Time settings, exercise selection, system setup.

The COMM module 5730 handles all radio and intercom communication types.

The radio portion is the trainees communication method replicating the real aircraft radio. Radio selection is through frequencies. Intercom includes intercom between fighter stations, the IOS and other external systems. The intercom is based VOIP, and Video Over IP is also optional.

The participants list 5740 is the module which holds all participants active and semi-active in the exercise. Participant selection can be achieved by either graphical selection on the 3D map or by graphical selection from the list. Basic participant properties are displayed along side each participant. These properties include location, heading, altitude, ammunition, radio data, online status and participant type.

Items Properties unit 5750: Double clicking any item in the system will open its properties in the properties window. Through this window, properties may be viewed, edited and created. The items that can be displayed include participants, shells, engines, scenarios, exercises, areas and trainees.

The database module 5760 holds the building blocks required to create an exercise. Each building block is based on smaller blocks also held in the database. The blocks include shells, engines, participants, scenarios, areas, environments and exercises.

The engine list 5770 holds all engines that can be used to drive participants in the exercise. The list shows the online/offline status of the engines. Once an engine has come online its parameters will be saved in the database 5760 for future planning.

The drop zone area 5780 is used to extract data from items that are graphically dragged into it. The data extracted is dependent on the drop zone type. For example, dragging an aircraft to the radio drop zone will extract the aircraft's radio frequencies allowing the user to quickly communicate with that aircraft. Drop zone types include radio, intercom, tracking, video over IP and voice over IP.

Once data has been extracted from an item it is held in the Data module 5790. Each drop zone has its own data module. The data module remembers past extracted information and allows quick reference to that data. An example is the radio data holding the last 10 frequencies extracted.

One or more external systems such as the various stations shown and/or additional distributed mission trainer units, may also be provided. The fighter stations 5800 are the stations for the pilot trainees. In the case of aircraft fighters, these stations are F-16 cockpits. Hardware is F-16 cockpit by Real-Simulator, Madrid—Spain. Software is Airbook builder by Simigon, Herzlia—Israel. The ground control station 5810 is an Air Traffic Controller station used for a ground controller trainee. Station is the ATC by IAI, LOD—Israel. The debriefing station 5820 records all that occurs within the exercise and within the local fighter stations. The information includes location, armament events, chaff & flare damage, avionics operations and communication. The Station may comprise the Debriefing Station by Israel Aircraft Industries (IAI), Lod, Israel. The CGF station 5830 is the module which drives CGF participants in the exercise and may comprise the STAGE system by ENSCO. INC, Springfield—Virginia. External CGF Stations 5840 and additional DMTs 5850, if any, are typically HLA compatible.

A typical connection structure includes one, some or all of the typically two way connections indicated by arrows with Roman numerals and are now described:

I. Drop Zone—Data. Passes the extracted information from the drop zone to the data module 5790 and the saved data from the data module 5790 to the drop zone 5780.

II. Exercise—Drop Zone. Passes the participants' information from the exercise 5710 to the drop zone 5780 for data extraction.

III. Exercise—Participants List. All participants displayed in the list are in the exercise 5710 and any manipulation of them from the exercise 5710 or from the list 5770 may influence the latter.

IV. Exercise—COMM. Passes all radio, intercom, voice and video over IP from the exercise and IOS to all external systems.

V. Exercise—Exercise Control. Passes all exercise commands from the control module 5720 to the exercise 5710. Keeps the control module 5720 updated as to the exercise status.

VI. Exercise—Multi-Operation Manager. All exercise information is passed to the external systems through the manager 5860 which coordinates the data and makes sure it is HLA compliant. The manager passes external data to the main exercise module 5710.

VII. Exercise—Item Properties. Item selection can occur through the exercise module passing to the properties module 5750 which item properties are needed to be displayed. Updated properties will pass from the properties module 5750 to the exercise module 5710.

VIII: Exercise—Database. Blocks are imported from the database 5760 into the exercise module 5710. Updated blocks in the exercise module may be saved to the database 5760.

IX: Exercise—Engine List. Engines selected from the list 5770 will drive the participants in the exercise. Engine status, with regard to which participant, their driving, is passed from the exercise 5710 to the list 5770.

X. Multi-Operation Manager—Additional DMT. HLA compliant communication passing all required data as defined by the HLA. Additional administrative requests including participant settings, exercise rules and coordinating data.

XI. Multi-Operation Manager—External CGF Station. HLA compliant communication passing all required data as defined by the HLA. Additional administrative requests including participant settings, exercise rules and coordinating data.

XIII. Multi-Operation Manager—Debriefing Station. HLA compliant communication passing all required data as defined by the HLA. Additional radio transmission data and basic operating command may be required. The commands include start record, pause and stop.

XIV, XV, XVI, XVII. Multi-Operation Manager—Fighter Station. HLA compliant communication passing all required data as defined by the HLA. Additional administrative requests including configuration, start location, system definitions and mission planning. In addition Radio communication and intercom may be employed.

XVIII. Multi-Qperation Manager—Ground Control Station. HLA compliant communication passing all required data as defined by the HLA. In addition radio communication and intercom are required.

XIX. COMM—Multi-Operation Manager. A connection passing all radio, intercom, voice over IP and video over IP.

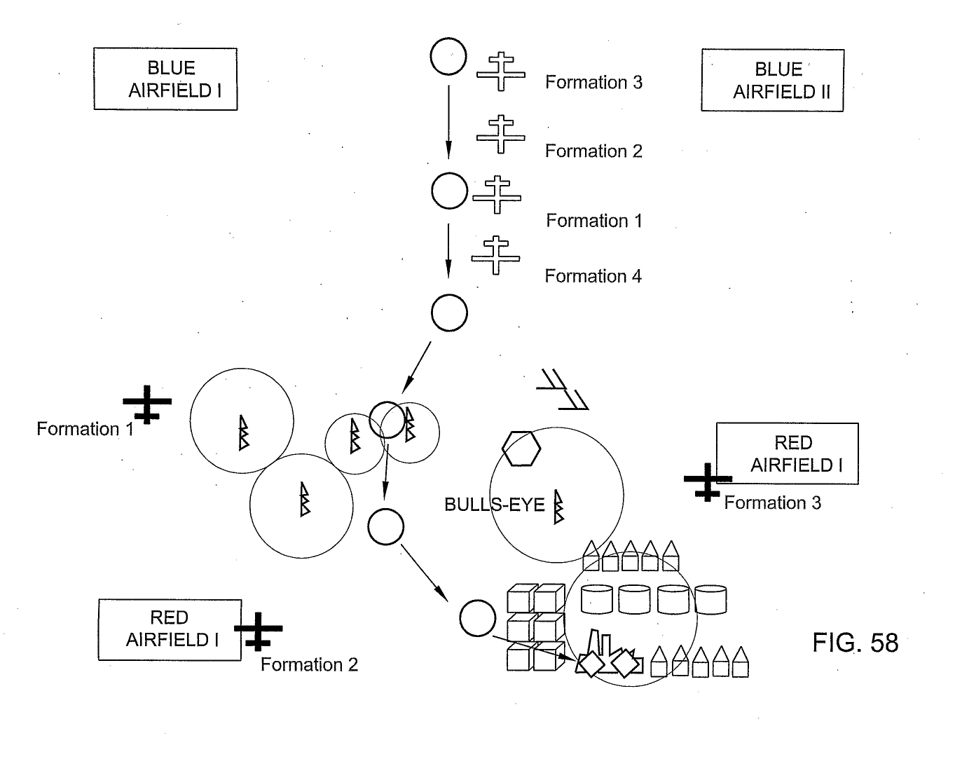

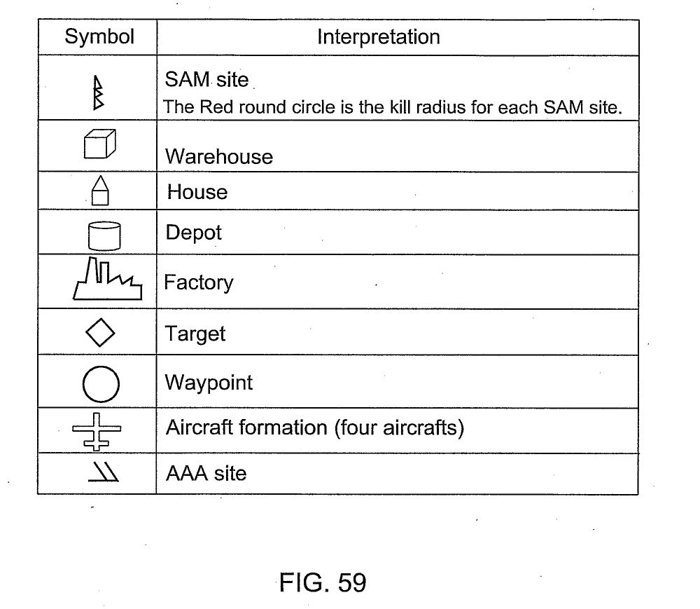

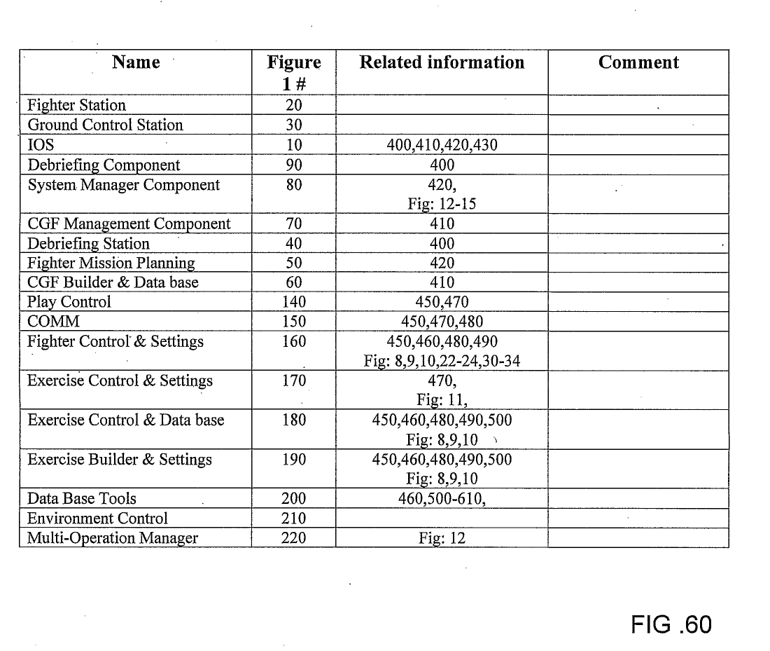

With reference to FIGS. 58-59, an example of an operation management session operative in accordance with certain embodiments of the present invention, is now described. FIG. 58 is an example of utilization of the Mission Training Center Manager system shown and described herein.

The following is a made up exercise that will be created later on in the system, comprising a Combined Air-Air Air-Ground Campaign. Blue Force Participants include Four F-16C from the local DMT, Four F-16A from the local CGF generator, Four F-16I from an external DMT, Four F-15I from real aircrafts, Ground Control Intercept. (GCI). Red Force Participants include Four Mig 29 from the local CGF generator, Four Mig 21 from an external CGF generator, Four Mig 23 from an external DMT generator, Ground Control Intercept. (GCI), Two SA-2 SAM sites from the local CGF generator, Two SA-3 SAM sites from the local CGF generator, Two SA-8 SAM sites from an external CGF generator, and Two TZU AAA vehicles from an external CGF generator. Target Structure and Area may include a number of large warehouses, a number of large fuel depots, a number of regular houses, and a large factory.

As for the Scenario Story, the initial picture may be that the Blue force's mission is to attack the factory. The Red force's mission is to protect the factory. The Blue force contains four formations. Blue formations 2 and 3 carry mainly air-to-ground ordinance and are in charge of attacking the targets. Formations 1 and 4 carry Air-to-Air ordinance and their job is mainly to protect the attacking formations. The Blue force can either start at their home bases on the ground, or start as displayed on the map. The Red force contains three formations and additional SAM and AAA sites. Red force 1 caps along the border when the blue force approaches it. Red forces 2 and 3 are on alert on the ground, each at its own base. The SAM sites are active where each site has its own reaction time. The initial game settings are shown in FIG. 58. The object index is shown in FIG. 59.

The mission story may be that the Blue force crosses the border, each formation at its pre-determined time. The time between Blue formations is one minute. The Red formation 1, which has been capping, discovers the entrance, and tries to intercept the Blue force, while the rest of the Red formations take off. Blue formation 4 kills Red formation 1. Blue formation 1 intercepts Red formation 2 and calls for assistance from Blue formation 4. Blue formation 4 calls on the attacking formation to hold and wait. The attacking formations start 360 degree turns. The Red formation 3, that has taken off, flies north and starts a cap waiting for the forces on their exit. Blue formation 1 calls on the attackers to continue. The attackers continue their navigation, cross the SA-8 SAM site and defend it from its missiles. The attackers continue and attack the factory. All the Blue formations return north. Red formation 3 intercepts them, and an additional fight occurs with the closest Blue formations. Whoever stayed alive returns to base.

The mission results may include the following four engagements:

a. Blue formation 4 killed all Red formation 1 with two Aim-120 missiles and two Aim-9L missiles. Two additional Aim-120 were trashed by Red formation 1 maneuvers. Two of Blue formation 4 were killed by one AA-10 missile and one SA-2 missile. Two additional AA-10's, one additional AA-8 and one additional SA-2 missile were trashed by Blue formation 4 maneuvers.

b. Blue formation 1 killed all of Red formation 2 with three P-4 missiles and one gun kill. Two of Blue formation 1 were killed, one by an AA-2 missile and another by an SA-8 missile.

c. Blue formations 2 and 3 navigate to the target and attack it. One of formation 2 was killed by an SA8 missile on the ingress. The rest of the seven attackers all dropped their bombs on their targets. Two of formation 2 hit the target directly. The third of formation 2 hit 50 meters south. Three of formation 3 hit their target directly, the fourth of formation 3 hit 50 meters east.

d. Red Formation 3 is killed by two Aim-120 shots from Blue formation 4 and by one P-4 shot from Blue formation 1 and by one Aim-9L shot from Blue formation 3. One of Blue formation 3 was killed by an AA-8 missile and one of Blue formation 4 was killed by an SA-3 missile. Two SA-3 missiles were trashed by maneuvering. Two AA-8 shots were trashed by maneuvering. One Aim-120 shot was trashed by maneuvering.

After these engagements, what is left of the Blue force returns home.

The Operation steps required to setup the exercise may include base database creation, scenario creation, exercise creation. Then the exercise is run and finally ended, all e.g. as described below:

Base database creation: Each of the potential participants is defined. In this case: F-16A, F-16C, F-16I, F-15I, Mig-21, Mig-23, Mig-29, SA-2, SA-3, SA-8, TZU, warehouse, depot, house, factory and airfield. The act of creating these database templates is actually the creation of database Shells. Each Shell is selected, by double clicking it, and its definitions are altered through the properties windows and all its sub tabs and options. The definitions include some or all of: Type: aircraft, ground vehicle, object; Configuration: fuel, armament, systems and size; Mission: routes, objective, targets; Behavior: Rules of engagement (fire at will, fire after visual identification, fire after GCI identification, fire after hostile act); Doctrine: Act according to pre-defined rules. Doctrines are built and defined in the CGF external system (STAGE). Doctrine can also be named mission or script in some systems.

Training area creation: Setting the area may comprise creating a new area. Double clicking it to open its properties window. Defining the area but selecting the area limits (through point on the map) and altitude limits (through entering data in the appropriate window). Once the area is defined it can be saved to the area database.

Environment creation: The environment is set by creating a new environment. Double clicking it to open its properties window. Defining it by setting its properties which may for example include Cloud amount and location, Wind and wind table, and/or Lighting settings.

In scenario creation, an area must be selected from the area database and attached to the scenario. An environment is selected and attached to the scenario. Shell templates are dragged and dropped at their required position to create the initial picture of the objects. Engines from the engine list are dragged onto their appropriate Shells to create the final participants. The F-16C shells will receive the local fighter stations engines. The F-16A shells will receive the local CGF station (STAGE) engine. The F-16I shells will receive the fighter stations from an additional DMT system. The F-15I shells will receive the real aircraft engines from an HLA to real data link gateway engine. The Mig 29, SA-2, SA-3 shells will receive the local CGF engine. The Mig 21, Mig 23, SA-8, TZU AAA shells will receive the external CGF generator. The scenario can be saved at every stage of its creation, it is not required to link all engines with shells for a scenario to be saved.

Exercise creation: Once at least one scenario is created and loaded onto an exercise, pressing the play button will start all systems which are logged on (engine+shell). The debriefing system automatically receives a start record with the exercise initiation.

At run time, any participant may be removed during operation by simply selecting it and pressing the remove button. Every shot taken creates an event that is displayed in the message window. Clicking the event will immediately center the 3D map on the event location. Pressing the exercise stop button stops the exercise, ends the recording and sends a stop message to all engines.

FIG. 60 is a table showing possible relationships between the various elements of the invention shown and described herein.

Any suitable processor, display and input means may be used to process, display and accept information as described herein, such as but not limited to a conventional personal computer processor; display screen and/or printer; and keyboard/mouse.

Programs and data described herein may be stored in any suitable computer-readable medium such as but not limited to disks of various kinds, cards of various kinds, RAMs, and ROMs such as CD-ROMs, EPROMs and EEPROMs.

Workstations practicing the invention shown and describe herein may communicate via any conventional wired or wireless digital communication means, optionally via a communication network such as the World Wide Web.

According to one embodiment of the invention, the system may comprise one or more computers or other programmable devices, typically equipped with input devices such as a keyboard and mouse operative to allow users to provide input to the system as described herein, and output devices such as a printer or interface with communication network servers such as Internet servers or with communication devices such as a cellular telephone. Each computer may be programmed in accordance with some or all of the apparatus, methods, features and functionalities shown and described herein. Alternatively or in addition, the apparatus of the present invention may comprise a memory which is readable by a machine and which contains, stores or otherwise embodies a program of instructions which, when executed by the machine, comprises an implementation of some or all of the apparatus, methods, features and functionalities shown and described herein. Alternatively or in addition, the apparatus of the present invention may comprise a computer program implementing some or all of the apparatus, methods, features and functionalities shown and described herein and being readable by a computer for performing some or all of the methods of, and/or implementing some or all of the systems of, embodiments of the invention as described herein.

It is appreciated that software components of the present invention may, if desired, by implemented in ROM (read only memory) form. The software components may, generally, be implemented in hardware, if desired, using conventional techniques.

Features of the present invention which are described in the context of separate embodiments may also be provided in combination in a single embodiment. Conversely, features of the invention which are described for brevity in the context of a single embodiment may be provided separately or in any suitable subcombination.

1. Operation manager apparatus for a Mission Training Center system, the apparatus comprising:
a communication system operative to coordinate a plurality of participants corresponding to a plurality of engines; and
a real time participant modification functionality operative to carry out at least one modification of at least one characteristic of at least one participant during an exercise, including informing at least one of said plurality of participants via said communication system.

2. Apparatus according to claim 1 wherein said characteristic comprises the engine behind the participant and said modification comprises a replacement.

3. Apparatus according to claim 1 wherein said characteristic comprises at least one participant parameter.

4. Operation manager apparatus for a Mission Training Center system, the apparatus comprising:
a graphical exercise generator comprising a GUI which enables design of at least one component of an exercise including at least one role; and
an engine uploader operative to upload at least one role within said exercise onto at least one corresponding on-line engine,
thereby to enable an exercise to be designed by said graphical exercise generator independent of engine on/off line status.

5. Apparatus according to claim 4 wherein said engine uploader is operative to present a multi-parameter request to an on-line engine and to allow said engine to respond by overriding at least one parameter within the request.

6. Operation manager apparatus for a Mission Training Center system, the apparatus comprising:
a cast definition tool operative to enable a manager to define a cast for an exercise including a plurality of participants; and
an engine acceptance tool operative to enable the manager to select a plurality of engines to respectively represent the plurality of participants from among a population of on-line engines.

7. Operation manager apparatus for a simulative training system, the apparatus comprising:
a user interface, including a display screen, allowing a manager to manage the simulative training system including defining at least one object having at least one property,
the user interface having a drag and drop functionality operative to allow at least one object to be dragged and dropped into a zone on the screen and, responsively, to cause said zone to acquire at least one object property.

8. Apparatus according to claim 1 wherein said characteristics comprise the engine behavior behind the participant and said modifications comprise an update to the engine behavior.

9. Apparatus according to claim 1 wherein at least one of said plurality of engines comprises an entity selected from the following group: simulator stations for fighter jets, helicopters UAVs, soldiers, tanks, SAMs, Computer Generated forces Servers, Real aircrafts, helicopters, tanks, trucks, and soldiers.

10. Apparatus according to claim 1 wherein at least one of said plurality of participants comprises an engine having at least one defined characteristic selected from the following group: at least one game rule, at least one initial start up setting parameter, coordination data, and exercise joining admission authorization.

11. Apparatus according to claim 1 wherein at least one of said plurality of engines has at least one defined shell property selected from the following group of shell properties: initial start up location, type of ammunition to be used in the course of the exercise, start up time, team selection, behavior doctrine.

12. Apparatus according to claim 1 wherein said communication system is HLA compliant.

13. Apparatus according to claim 4 wherein said engine uploader is HLA compliant.

14. Apparatus according to claim 6 wherein said engine acceptance tool comprises an HLA-compliant communication system for communicating with said on-line engines.

15. A method for operation management of a Mission Training Center system, the method comprising:
using a communication system to coordinate a plurality of participants corresponding to a plurality of engines; and
carrying out at least one modification of at least one characteristic of at least one participant during exercise operation, including informing at least one of said plurality of participants via said communication system.

16. A method for operation management of a Mission Training Center system, the method comprising:
using a GUI to design at least one component of an exercise including at least one role; and
uploading at least one role within said exercise onto at least one corresponding on-line engine,
thereby to enable an exercise to be designed independent of engine on/off line status.

17. A method for operation management of a Mission Training Center system, the method comprising:
enabling a manager to define a cast for an exercise including a plurality of participants; and
enabling the manager to select a plurality of engines to respectively represent the plurality of participants from among a population of on-line engines.

18. A method for operation management of a simulative training system, the method comprising:
providing a user interface allowing a manager to manage the simulative training system including defining at least one object having at least one property, the user interface having a drag and drop functionality operative to allow at least one object to be dragged and dropped into a zone on the screen and, responsively, to cause said zone to acquire at least one object property.

19. Apparatus according to claim 1 wherein said characteristic comprises a behavior of an engine corresponding to a participant.

20. Apparatus according to claim 1 wherein said modification is carried out during at least one of an exercise set-up stage and an exercise operation stage.

21. A program storage device readable by machine, tangibly embodying a program of instructions executable by the machine to perform method steps of operation management of a Mission Training Center system, the method comprising:
using a communication system to coordinate a plurality of participants corresponding to a plurality of engines; and
carrying out at least one modification of at least one characteristic of at least one participant during exercise operation, including informing at least one of said plurality of participants via said communication system.

22. A computer program product comprising a computer useable medium having computer readable program code having embodied therein a method for operation management of a Mission Training Center system, said computer program product comprising:
computer readable program code for using a communication system to coordinate a plurality of participants corresponding to a plurality of engines; and
computer readable program code for carrying out at least one modification of at least one characteristic of at least one participant during exercise operation, including informing at least one of said plurality of participants via said communication system.

23. A program storage device readable by machine, tangibly embodying a program of instructions executable by the machine to perform method steps of operation management of a Mission Training Center system, the method comprising:
using a GUI to design at least one component of an exercise including at least one role; and
uploading at least one role within said exercise onto at least one corresponding on-line engine,
thereby to enable an exercise to be designed independent of engine on/off line status.

24. A computer program product comprising a computer useable medium having computer readable program code having embodied therein a method for operation management of a Mission Training Center system, said computer program product comprising:
computer readable program code for using a GUI to design at least one component of an exercise including at least one role; and
computer readable program code for uploading at least one role within said exercise onto at least one corresponding on-line engine,
thereby to enable an exercise to be designed independent of engine on/off line status.

25. A program storage device readable by machine, tangibly embodying a program of instructions executable by the machine to perform method steps of operation management of a Mission Training Center system, the method comprising:
enabling a manager to define a cast for an exercise including a plurality of participants; and
enabling the manager to select a plurality of engines to respectively represent the plurality of participants from among a population of on-line engines.

26. A computer program product comprising a computer useable medium having computer readable program code having embodied therein a method for operation management of a Mission Training Center system, said computer program product comprising:
computer readable program code for enabling a manager to define a cast for an exercise including a plurality of participants; and
computer readable program code for enabling the manager to select a plurality of engines to respectively represent the plurality of participants from among a population of on-line engines.

27. A program storage device readable by machine, tangibly embodying a program of instructions executable by the machine to perform method steps of operation management of a simulative training system, the method comprising:
providing a user interface allowing a manager to manage the simulative training system including defining at least one object having at least one property, the user interface having a drag and drop functionality operative to allow at least one object to be dragged and dropped into a zone on the screen and, responsively, to cause said zone to acquire at least one object property.

28. A computer program product comprising a computer useable medium having computer readable program code having embodied therein a method for operation management of a simulative training system, said computer program product comprising:
computer readable program code for providing a user interface allowing a manager to manage the simulative training system including defining at least one object having at least one property, the user interface having a drag and drop functionality operative to allow at least one object to be dragged and dropped into a zone on the screen and, responsively, to cause said zone to acquire at least one object property.

29. Apparatus according to claim 7 wherein said object property comprises at least one communication channel over which the object can communicate.
